(19) United States
(12) Patent Application Publication
(10) Pub. No.: US 2013/0121564 A1
(43) Pub. Date: May 16, 2013

(54) POINT CLOUD DATA PROCESSING DEVICE, POINT CLOUD DATA PROCESSING SYSTEM, POINT CLOUD DATA PROCESSING METHOD, AND POINT CLOUD DATA PROCESSING PROGRAM

(71) Applicant: KABUSHIKI KAISHA TOPCON, Tokyo (JP)

(72) Inventors: Kazuo KITAMURA, Tokyo (JP); Nobuo KOCHI, Tokyo (JP); Tadayuki ITO, Tokyo (JP); Hitoshi OTANI, Tokyo (JP)

(73) Assignee: KABUSHIKI KAISHA TOPCON, Tokyo (JP)

(21) Appl. No.: 13/733,643

(22) Filed: Jan. 3, 2013

Related U.S. Application Data
(63) Continuation of application No. PCT/JP2011/064756, filed on Jun. 28, 2011.

(30) Foreign Application Priority Data
Jul. 5, 2010 (JP) 2010-153318

(51) Int. Cl. G06K 9/46

(52) U.S. Cl. CPC G06K 9/4671
USPC 382/154

(57) ABSTRACT

A point cloud data processing device is equipped with a non-plane area removing unit 101, a plane labeling unit 102, a contour calculating unit 103, and a point cloud data remeasurement request processing unit 106. The non-plane area removing unit 101 removes point cloud data relating to non-plane areas from point cloud data in which a two-dimensional image of an object is linked with data of three-dimensional coordinates of plural points that form the two-dimensional image. The plane labeling unit 102 adds labels for identifying planes with respect to the point cloud data in which the data of the non-plane areas are removed. The contour calculating unit 103 calculates a contour of the object by using local flat planes based on a local area that is connected with the labeled plane. The point cloud data remeasurement request processing unit 106 requests remeasurement of the point cloud data.

### RELATED APPLICATIONS

This application is a continuation of PCT/JP2011/064756 filed on Jun. 28, 2011, which claims priority to Japanese Application No. 2010-153318 filed on Jul. 5, 2010. The entire contents of these applications are incorporated herein by reference.

### FIELD OF THE INVENTION

The present invention relates to point cloud data processing techniques, and specifically relates to a point cloud data processing technique that extracts features of an object from point cloud data thereof and that automatically generates a three-dimensional model in a short time.

### DESCRIPTION OF RELATED ART

As a method for generating a three-dimensional model from point cloud data of an object, a method of connecting adjacent points and forming polygons may be used. In this case, in order to form polygons from several tens of thousands to tens of millions of points of the point cloud data, enormous amounts of processing time are required, and this method is not useful. In view of this, the following techniques are disclosed in, for example, Japanese Unexamined Patent Application Publication (Translation of PCT Application) No. 2000-509150 and Japanese Unexamined Patent Applications Laid-open Nos. 2004-272459 and 2005-024370. In these techniques, only three-dimensional features (edges and planes) are extracted from point cloud data, and three-dimensional polylines are automatically generated.

In the invention disclosed in Japanese Unexamined Patent Application Publication (Translation of PCT Application) No. 2000-509150, a scanning laser device scans a three-dimensional object and generates point clouds. The point cloud is separated into a group of edge points and a group of non-edge points, based on changes in depths and normal lines of the scanned points. Each group is fitted to geometric original drawings, and the fitted geometric original drawings are extended and are crossed, whereby a three-dimensional model is generated.

In the invention disclosed in Japanese Unexamined Patent Application Laid-open No. 2004-272459, segments (triangular polygons) are formed from point cloud data, and edges and planes are extracted based on continuity, directions of normal lines, or distance, of adjacent polygons. Then, the point cloud data of each segment is converted into a flat plane equation or a curved plane equation by the least-squares method and is grouped by planarity and curvature, whereby a three-dimensional model is generated.

In the invention disclosed in Japanese Unexamined Patent Application Laid-open No. 2005-024370, two-dimensional rectangular areas are set for three-dimensional point cloud data, and synthesized normal vectors of measured points in the rectangular areas are obtained. All of the measured points in the rectangular area are rotationally shifted so that the synthesized normal vector corresponds to a z-axis direction. Standard deviation ? of z value of each of the measured points in the rectangular area is calculated. Then, when the standard deviation ? exceeds a predetermined value, the measured point corresponding to the center point in the rectangular area is processed as noise.

### SUMMARY OF THE INVENTION

One of the applications of use of three-dimensional information of an object, which is obtained by a laser device, a stereo imaging device, or the like, is to obtain data for three-dimensional CAD by extracting features of the object. In this case, it is important to obtain necessary data automatically in a short operation time. In view of these circumstances, an object of the present invention is to provide a technique for extracting features of an object from point cloud data thereof and automatically generating data relating to contours of the object in a short time.

According to a first aspect of the present invention, the present invention provides a point cloud data processing device including a non-plane area removing unit, a plane labeling unit, a contour calculating unit, and a point cloud data remeasurement request processing unit. The non-plane area removing unit removes points of non-plane areas based on point cloud data of an object. The plane labeling unit adds identical labels to points in the same planes other than the points removed by the non-plane area removing unit so as to label planes. The contour calculating unit calculates a contour at a portion between a first plane and a second plane, which have the non-plane area therebetween and have a different label. The contour differentiates the first plane and the second plane. The point cloud data remeasurement request processing unit requests remeasurement of the point cloud data based on at least one of results of the processing performed by the non-plane area removing unit, the plane labeling unit, and the contour calculating unit. The contour calculating unit includes a local area obtaining unit for obtaining a local area between the first plane and the second plane and includes a local space obtaining unit for obtaining a local plane or a local line. The local area connects with the first plane and is based on the point cloud data of the non-plane area. The local plane fits to the local area and differs from the first plane and the second plane in direction. The local line fits to the local area and is not parallel to the first plane and the second plane. The contour calculating unit calculates the contour based on the local plane or the local line.

In the point cloud data, a two-dimensional image is linked with three-dimensional coordinates. That is, in the point cloud data, data of a two-dimensional image of an object, plural measured points that are matched with the two-dimensional image, and positions (three-dimensional coordinates) of the measured points in a three-dimensional space, are associated with each other. According to the point cloud data, an outer shape of the object is reproduced by using a set of points. Since three-dimensional coordinates of each point are obtained, the relative position of each point is determined. Therefore, a screen-displayed image of an object can be rotated, and the image can be switched to an image that is viewed from a different viewpoint.

In the first aspect of the present invention, the label is an identifier for identifying a plane (or differentiating a plane from other planes). The plane is appropriate to be selected as a target object to be calculated and includes a flat plane, a curved plane with a large curvature, and a curved plane of which curvature is large and varies slightly according to position. In the present invention, the plane and the non-plane are differentiated according to whether the amount of calculation is acceptable or not when the plane and the non-plane are mathematically processed as data by the calculation. The non-plane includes a corner, an edge portion, a portion with a small curvature, and a portion of which curvature greatly varies according to position. These portions require an enormous amount of calculation when they are mathematically processed as data by the calculation, which applies a high load on a processing device and causes increase of operation time. In the present invention, decreasing of the operation time is one of the objects of the present invention. In view of this, planes, which apply a high load on the processing device and cause increase of the operation time, are removed as non-planes so as not to calculate such planes as much as possible.

In the first aspect of the present invention, one plane and another plane, which have a non-plane area therebetween, are used as the first plane and the second plane. In general, when the non-plane area is removed, the two planes that had the non-plane area therebetween are the first plane and the second plane which are adjacent to each other.

Contours are lines (outlines) that form an outer shape of an object and that are necessary to visually understand the appearance of the object. Specifically, bent portions, and portions, of which curvatures are suddenly decreased, are the contours. The contours are not only outside frame portions but also edge portions, which characterize convexly protruding portions, and edge portions, which characterize concavely recessed portions (for example, grooved portions). According to the contours, the so-called “line figure” is obtained, and an image that enables easily understanding of the appearance of the object is displayed. Actual contours exist on boundaries between the planes and on the edge portions, but in the present invention, these portions are removed as non-plane areas from the point cloud data. Therefore, the contours are estimated by calculation as described below.

In the first aspect of the present invention, areas that correspond to corners and edge portions of an object are removed as non-plane areas, and the object is electronically processed by a set of planes that are easy to use together as data. According to this function, the appearance of the object is processed as a set of plural planes. Therefore, the amount of data to be dealt with is decreased, whereby the amount of calculation that is necessary to obtain three-dimensional data of the object is decreased. As a result, processing time of the point cloud data is decreased, and processing time for displaying a three-dimensional image of the object and processing times of various calculations based on the three-dimensional image of the object are decreased.

On the other hand, as three-dimensional CAD data, information of three-dimensional contours of an object (data of a line figure) is required in order to visually understand the shape of the object. However, the information of the contours of the object exists between planes and is thereby included in the non-plane areas. In view of this, in the first aspect of the present invention, first, the object is processed as a set of planes that require a small amount of calculation, and then contours are estimated by assuming that each contour exists between adjacent planes.

A portion of a contour of the object may include a portion in which curvature changes sharply, such as an edge, or the like. In this regard, it is not efficient to obtain data of the contours by directly calculating obtained point cloud data, because the amount of calculation is increased. In the first aspect of the present invention, point cloud data in the vicinities of contours are removed as non-plane areas, and planes are extracted based on point cloud data of planes that are easy to calculate, first. Then, a local area, and a local plane (two-dimensional local space) or a local line (one-dimensional local space), which fits to the local area, are obtained. The local area connects with the obtained plane and is based on the point cloud data of the non-plane area, which have been already removed.

The local plane is a local plane that fits to a local area of 5×5 points or the like. The calculation will be simpler if a flat plane (local flat plane) is selected as the local plane, but a curved plane (local curved plane) may be selected as the local plane. The local line is a curved line segment that fits to the local area. The calculation will be also simpler if a straight line (local straight line) is used as the local line, but a curved line (local curved line) may be used as the local line.

The local plane fits to the shape of the non-plane area more than in the case of the first plane. The local plane reflects the condition of the non-plane area between the first plane and the second plane, although it does not completely reflect the condition, whereby the local plane differs from the first plane and the second plane in the direction (normal direction).

Since the local plane reflects the condition of the non-plane area between the first plane and the second plane, a contour is obtained at high approximation accuracy by calculating based on the local plane. In addition, according to this method, the non-plane area is approximated by the local plane, whereby the amount of calculation is decreased. These effects are also obtained in the case of using the local line.

In the first aspect of the present invention, the local area may be adjacent to the first plane or may be at a position distant from the first plane. When the local area is at a position distant from the first plane, the local area and the first plane are connected by one or plural local areas. Continuity of areas is obtained when the following relationship is obtained. That is, the first plane and a local area that is adjacent to the first plane share points, for example, share an edge portion, and the local area and another local area that is adjacent to the local area share other points.

In the first aspect of the present invention, the plane and the non-plane are differentiated based on parameters that are indexes of appropriateness of using a plane as the plane. As the parameters, (1) local curvature, (2) fitting accuracy of a local flat plane, and (3) coplanarity, are described.

The local curvature is a parameter that indicates variation of normal vectors of a target point and surrounding points. For example, when a target point and surrounding points are in the same plane, a normal vector of each point does not vary, whereby the local curvature is smallest.

The local flat plane is obtained by approximating a local area by a flat plane. The fitting accuracy of the local flat plane is an accuracy of correspondence of the calculated local flat plane to the local area that is the base of the local flat plane. The local area is a square area (rectangular area) of approximately 3 to 9 pixels on a side, for example. The local area is approximated by a flat plane (local flat plane) that is easy to process, and an average value of distances between each point in a target local area and a corresponding local flat plane is calculated. The fitting accuracy of the local flat plane to the local area is evaluated by the average value. For example, if the local area is a flat plane, the local area corresponds to the local flat plane, and the fitting accuracy of the local flat plane is highest (best).

The coplanarity is a parameter that indicates a difference of directions of two planes that are adjacent or close to each other. For example, when adjacent flat planes cross each other at 90 degrees, normal vectors of the adjacent flat planes orthogonally cross each other. When an angle between two adjacent flat planes is smaller, an angle between normal vectors of the two adjacent flat planes is smaller. By utilizing this function, whether two adjacent planes are in the same plane or not, and the amount of the positional difference of the two adjacent planes if they are not in the same plane, are evaluated. This amount is the coplanarity. Specifically, when inner products of normal vectors of two local flat planes, which fit to two target local areas, respectively, and a vector connecting center points of the local flat planes, are zero, the local flat planes are determined to be in the same plane. When the inner products are greater, the amount of the positional difference of the two local flat planes is determined to be greater.

A threshold value is set for each of the parameters of (1) local curvature, (2) fitting accuracy of local flat plane, and (3) coplanarity, and the plane and the non-plane are differentiated according to the threshold values. In general, sharp three-dimensional edges that are generated by change of directions of planes, and non-plane areas that are generated by curved planes with large curvatures, such as smooth three-dimensional edges, are evaluated by the (1) local curvature. Non-plane areas that are generated by occlusion, such as three-dimensional edges, are evaluated mainly by the (2) fitting accuracy of local flat plane because they have points of which positions suddenly change. The “occlusion” is a condition in which the inner portions are hidden by the front portions and cannot be seen. Non-plane areas that are generated by change of directions of planes, such as sharp three-dimensional edges, are evaluated mainly by the (3) coplanarity.

The evaluation for differentiating the plane and the non-plane may be performed by using one or a plurality of the three kinds of the parameters. For example, when each of the three kinds of the evaluations is performed on a target area, and the target area is identified as a non-plane by at least one of the evaluations, the target area is identified as a non-plane area.

In the method of calculating a contour by obtaining labeled portions as planes and then setting a local area at a non-plane area, the contour is not calculated at high accuracy and contains a lot of errors because the accuracy of the point cloud data does not reach a necessary level. Therefore, images of outlines of an object may not be correctly displayed on the screen (for example, a part of the outline may be indistinct). As the reasons for not obtaining the point cloud data at a necessary level, effects of passing vehicles and passersby during taking of the point cloud data, effects of weather and lighting, rough density of the point cloud data, and the like, may be described.

Responding to this problem, in the present invention, a processing of request for remeasurement of the point cloud data is performed based on at least one of results of the processing performed by the non-plane area removing unit, the plane labeling unit, and the contour calculating unit. Thus, the point cloud data is remeasured, recalculation is performed based on the remeasured point cloud data. By performing recalculation, the reasons for decreasing the accuracy of the calculation are decreased or removed. In addition, the measuring density of point cloud data, that is, the density of measured points on the object for obtaining point cloud data, may be increased to be higher than before when the point cloud data is remeasured. In this case, the reasons for decreasing the accuracy of the calculation are decreased or removed.

According to a second aspect of the present invention, in the first aspect of the present invention, the point cloud data remeasurement request processing unit may request remeasurement of the point cloud data of the non-plane area. The accuracy is important in the calculation of the contour, that is, in the calculation relating to the non-plane area. In the first aspect of the present invention, the local area is obtained based on the point cloud data of the non-plane area, and the local plane or the local line, which fits to the local area, is obtained, whereby the contour is calculated based on the local plane or the local line. Therefore, the calculation is performed partially based on the point cloud data of the non-plane area. Accordingly, if there is a problem with the calculation accuracy of contour, it is expected that the point cloud data of the non-plane area contain errors or does not have a necessary accuracy. According to the second aspect of the present invention, remeasurement of the point cloud data of the non-plane area is requested, whereby the calculation accuracy of contour is increased. Moreover, since remeasurement of the point cloud data of the labeled planes is not requested, the processing relating to remeasurement of the point cloud data is efficiently performed.

According to a third aspect of the present invention, in the first or the second aspect of the present invention, the point cloud data processing device may further include an accuracy evaluating unit for evaluating accuracy of the addition of the identical labels and the accuracy of the calculation of the contour. In this case, the point cloud data remeasurement request processing unit requests remeasurement of the point cloud data based on the evaluation performed by the accuracy evaluating unit. According to the third aspect of the present invention, the accuracy of the addition of the identical labels and the accuracy of the calculation of the contour are automatically evaluated, and the remeasurement of the point cloud data is requested based on the evaluation. Therefore, the point cloud data can be automatically remeasured, and the contour is calculated by the subsequent calculation at higher accuracy without instructions by a user.

According to a fourth aspect of the present invention, in one of the first to the third aspect of the present invention, the point cloud data processing device may further include a receiving unit for receiving instruction for requesting remeasurement of the point cloud data of a selected area. According to the fourth aspect of the present invention, the calculation accuracy of contour in an area is increased according to the selection of a user. Depending on object and required condition of a figure, there may be areas in which high accuracy is required and areas in which high accuracy is not required. In this case, if the calculation is performed on all of the areas so as to obtain high accuracy, the processing time is increased by unnecessary calculation. In this regard, according to the fourth aspect of the present invention, the area of which the point cloud data need to be remeasured is selected by a user, and remeasurement of the point cloud data is requested based on the instruction. Therefore, the required accuracy and the reduction of the processing time are balanced.

According to a fifth aspect of the present invention, in one of the first to the fourth aspects of the present invention, the remeasurement of the point cloud data may be requested so as to obtain point cloud data at higher density than the point cloud data that are previously obtained. According to the fifth aspect of the present invention, in the area (target area) of the object, in which the point cloud data need to be remeasured, density of point cloud data in the remeasurement is set higher than that in the previous measurement. That is, the number of measured points per area is set higher than that in the point cloud data that are previously obtained. Thus, more fine point cloud data is obtained, whereby the accuracy of modeling is improved.

According to a sixth aspect of the present invention, in one of the first to the fifth aspects of the present invention, the point cloud data may contain information relating to intensity of light that is reflected at the object. In this case, the point cloud data processing device further includes a two-dimensional edge calculating unit for calculating a two-dimensional edge based on the information relating to the intensity of the light. The two-dimensional edge forms a figure within the labeled plane. Moreover, the point cloud data remeasurement request processing unit requests remeasurement of the point cloud data based on result of the calculation performed by the two-dimensional edge calculating unit.

The two-dimensional edge is a portion that is represented by a line in the labeled plane. For example, the two-dimensional edge includes patterns, changes in contrasting density, line patterns such as of tile joints, convex portions which are narrow and extends in longitudinal direction, connecting portions and boundary portions of members, and the like. These are not contours (outlines) that form the outer shape of the object in a precise sense, but they are lines that are effective for understanding the appearance of the object as in the case of the contours. For example, in a case of processing the appearance of a building as data, window frames with little projection and recess, and boundaries between members of exterior walls, are used as the two-dimensional edges. According to the sixth aspect of the present invention, the two-dimensional edge is calculated and is made so as to be recalculated, whereby data of a more realistic line figure of the appearance of the object is obtained.

According to a seventh aspect of the present invention, the present invention also provides a point cloud data processing device including a rotationally emitting unit, a distance measuring unit, an emitting direction measuring unit, and a three-dimensional coordinate calculating unit. This point cloud data processing device also includes a point cloud data obtaining unit, a non-plane area removing unit, a plane labeling unit, a contour calculating unit, and a point cloud data remeasurement request processing unit. The rotationally emitting unit rotationally emits distance measuring light on an object. The distance measuring unit measures a distance from the point cloud data processing device to a measured point on the object based on flight time of the distance measuring light. The emitting direction measuring unit measures emitting direction of the distance measuring light. The three-dimensional coordinate calculating unit calculates three-dimensional coordinates of the measured point based on the distance and the emitting direction. The point cloud data obtaining unit obtains point cloud data of the object based on result of the calculation performed by the three-dimensional coordinate calculating unit. The non-plane area removing unit removes points of non-plane areas based on the point cloud data of the object. The plane labeling unit adds identical labels to points in the same planes other than the points removed by the non-plane area removing unit so as to label planes. The contour calculating unit calculates a contour at a portion between a first plane and a second plane, which have the non-plane area therebetween and have a different label. The contour differentiates the first plane and the second plane. The point cloud data remeasurement request processing unit requests remeasurement of the point cloud data based on at least one of results of the processing performed by the non-plane area removing unit, the plane labeling unit, and the contour calculating unit. The contour calculating unit includes a local area obtaining unit for obtaining a local area between the first plane and the second plane and includes a local space obtaining unit for obtaining a local plane or a local line. The local area connects with the first plane and is based on the point cloud data of the non-plane area. The local plane fits to the local area and differs from the first plane and the second plane in direction. The local line fits to the local area and is not parallel to the first plane and the second plane. The contour calculating unit calculates the contour based on the local plane or the local line.

According to an eighth aspect of the present invention, the present invention also provides a point cloud data processing device including a photographing unit, a feature point matching unit, a photographing position and direction measuring unit, and a three-dimensional coordinate calculating unit. This point cloud data processing device also includes a point cloud data obtaining unit, a non-plane area removing unit, a plane labeling unit, a contour calculating unit, and a point cloud data remeasurement request processing unit. The photographing unit takes images of an object in overlapped photographing areas from different directions. The feature point matching unit matches feature points in overlapping images obtained by the photographing unit. The photographing position and direction measuring unit measures the position and the direction of the photographing unit. The three-dimensional coordinate calculating unit calculates three-dimensional coordinates of the feature points based on the position and the direction of the photographing unit and the positions of the feature points in the overlapping images. The point cloud data obtaining unit obtains point cloud data of the object based on result of the calculation performed by the three-dimensional coordinate calculating unit. The non-plane area removing unit removes points of non-plane areas based on the point cloud data of the object. The plane labeling unit adds identical labels to points in the same planes other than the points removed by the non-plane area removing unit so as to label planes. The contour calculating unit calculates a contour at a portion between a first plane and a second plane, which have the non-plane area therebetween and have a different label. The contour differentiates the first plane and the second plane. The point cloud data remeasurement request processing unit requests remeasurement of the point cloud data based on at least one of results of the processing performed by the non-plane area removing unit, the plane labeling unit, and the contour calculating unit. The contour calculating unit includes a local area obtaining unit for obtaining a local area between the first plane and the second plane and includes a local space obtaining unit for obtaining a local plane or a local line. The local area connects with the first plane and is based on the point cloud data of the non-plane area. The local plane fits to the local area and differs from the first plane and the second plane in direction. The local line fits to the local area and is not parallel to the first plane and the second plane. The contour calculating unit calculates the contour based on the local plane or the local line.

According to a ninth aspect of the present invention, the present invention also provides a point cloud data processing system including a point cloud data obtaining means, a non-plane area removing means, a plane labeling means, a contour calculating means, and a point cloud data remeasurement request processing means. The point cloud data obtaining means optically obtains point cloud data of an object. The non-plane area removing means removes points of non-plane areas based on the point cloud data of the object. The plane labeling means adds identical labels to points in the same planes other than the points removed by the non-plane area removing means so as to label planes. The contour calculating means calculates a contour at a portion between a first plane and a second plane, which have the non-plane area therebetween and have a different label. The contour differentiates the first plane and the second plane. The point cloud data remeasurement request processing means requests remeasurement of the point cloud data based on at least one of results of the processing performed by the non-plane area removing means, the plane labeling means, and the contour calculating means. The contour calculating means includes a local area obtaining means for obtaining a local area between the first plane and the second plane and includes a local space obtaining means for obtaining a local plane or a local line. The local area connects with the first plane and is based on the point cloud data of the non-plane area. The local plane fits to the local area and differs from the first plane and the second plane in direction. The local line fits to the local area and is not parallel to the first plane and the second plane. The contour calculating means calculates the contour based on the local plane or the local line.

According to a tenth aspect of the present invention, the present invention also provides a point cloud data processing method including a non-plane area removing step, a plane labeling step, a contour calculating step, and a point cloud data remeasurement request processing step. In the non-plane area removing step, points of non-plane areas are removed based on point cloud data of an object. In the plane labeling step, identical labels are added to points in the same planes other than the points removed in the non-plane area removing step so as to label planes. In the contour calculating step, a contour is calculated at a portion between a first plane and a second plane, which have the non-plane area therebetween and have a different label. The contour differentiates the first plane and the second plane. In the point cloud data remeasurement request processing step, remeasurement of the point cloud data is requested based on at least one of results of the processing performed in the non-plane area removing step, the plane labeling step, and the contour calculating step. The contour calculating step includes a local area obtaining step for obtaining a local area between the first plane and the second plane and includes a local space obtaining step for obtaining a local plane or a local line. The local area connects with the first plane and is based on the point cloud data of the non-plane area. The local plane fits to the local area and differs from the first plane and the second plane in direction. The local line fits to the local area and is not parallel to the first plane and the second plane. The contour is calculated based on the local plane or the local line.

According to an eleventh aspect of the present invention, the present invention also provides a point cloud data processing program to be read and executed by a computer so that the computer has the following functions. The functions include a non-plane area removing function, a plane labeling function, a contour calculating function, and a point cloud data remeasurement request processing function. The non-plane area removing function enables removal of points of non-plane areas based on point cloud data of an object. The plane labeling function enables addition of identical labels to points in the same planes other than the points, which are removed according to the non-plane area removing function, so as to label planes. The contour calculating function enables calculation of a contour at a portion between a first plane and a second plane, which have the non-plane area therebetween and have a different label. The contour differentiates the first plane and the second plane. The point cloud data remeasurement request processing function enables request of remeasurement of the point cloud data based on at least one of results of the processing performed by the non-plane area removing function, the plane labeling function, and the contour calculating function. The contour calculating function includes a local area obtaining function for obtaining a local area between the first plane and the second plane and includes a local space obtaining function for obtaining a local plane or a local line. The local area connects with the first plane and is based on the point cloud data of the non-plane area. The local plane fits to the local area and differs from the first plane and the second plane in direction. The local line fits to the local area and is not parallel to the first local plane and the second local plane. The contour is calculated based on the local plane or the local line.

According to the present invention, a technique for extracting features of an object from point cloud data thereof and automatically generating data relating to contours of the object in a short time is provided.

### BRIEF DESCRIPTION OF THE DRAWINGS

FIG. 1 is a block diagram of a point cloud data processing device of an embodiment.

FIG. 2 is a flow chart showing a processing flow of an embodiment.

FIG. 3 is a conceptual diagram showing an example of an object.

FIG. 4 is a conceptual diagram showing a condition of edges of labeled planes.

FIG. 5 is a conceptual diagram showing a function for calculating a contour.

FIGS. 6A and 6B are conceptual diagrams showing a function for calculating a contour.

FIGS. 7A and 7B are block diagrams showing examples of a contour calculating unit.

FIG. 8 is a conceptual diagram showing a relationship between edges of labeled planes and a contour.

FIG. 9 is a flow chart showing a processing flow of an embodiment.

FIG. 10 is a conceptual diagram of a point cloud data processing device including a function of a three-dimensional laser scanner.

FIG. 11 is a conceptual diagram of a point cloud data processing device including a function of a three-dimensional laser scanner.

FIG. 12 is a block diagram of a control system of an embodiment.

FIG. 13 is a block diagram of a processing unit of an embodiment.

FIG. 14 is a conceptual diagram showing an example of steps of forming a grid.

FIG. 15 is a conceptual diagram showing an example of a grid.

FIG. 16 is a conceptual diagram of a point cloud data processing device including a function of obtaining three-dimensional information by stereo cameras.

FIG. 17 is a block diagram of an embodiment.

### DETAILED DESCRIPTION OF THE PREFERRED EMBODIMENTS

### 1. First Embodiment

An example of a point cloud data processing device will be described with reference to the figures hereinafter. The point cloud data processing device in this embodiment is equipped with a non-plane area removing unit, a plane labeling unit, and a contour calculating unit. The non-plane area removing unit removes point cloud data relating to non-plane areas from point cloud data because the non-plane areas apply a high load in calculation. In the point cloud data, a two-dimensional image of an object is linked with data of three-dimensional coordinates of plural points that correspond to the two-dimensional image. The plane labeling unit adds labels to the point cloud data in which the data of the non-plane areas are removed, so as to identify planes. The contour calculating unit calculates a contour of the object by using a local flat plane that is based on a local area connected with the labeled plane. The point cloud data processing device is also equipped with a point cloud data remeasurement request processing unit 106 that performs processing relating to remeasurement of the point cloud data.

Structure of Point Cloud Data Processing Device

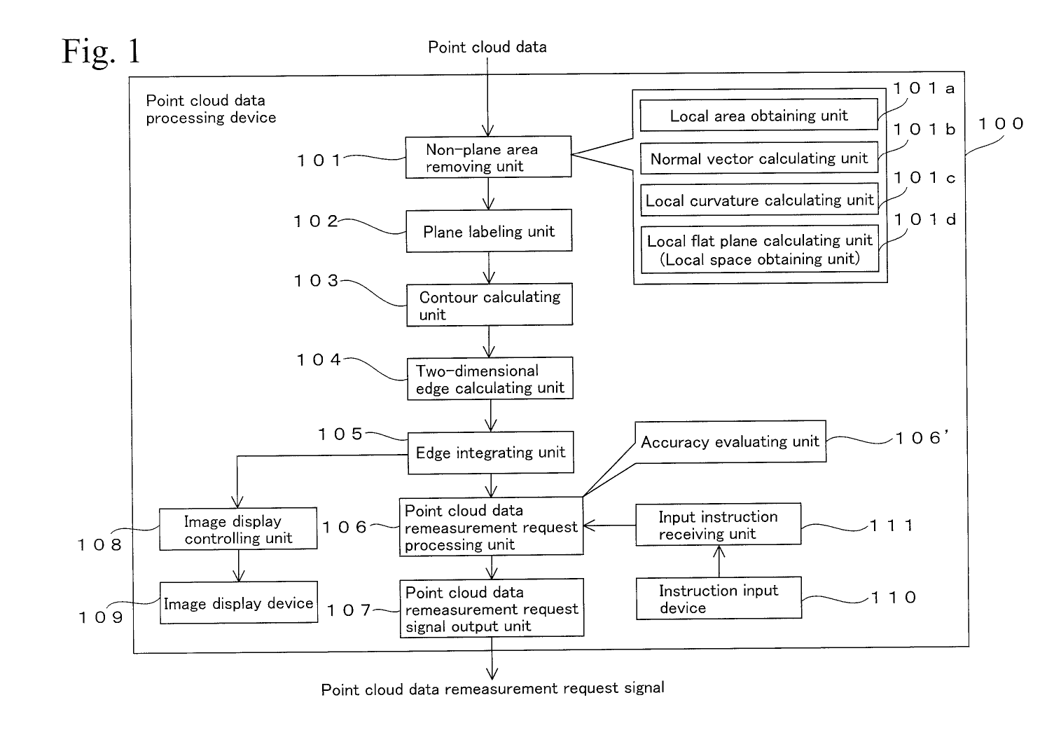

FIG. 1 is a block diagram of a point cloud data processing device 100. The point cloud data processing device 100 extracts features of an object based on point cloud data thereof and generates a three-dimensional model based on the features. The point cloud data is obtained by a three-dimensional position measuring device (three-dimensional laser scanner) or a stereoscopic image information obtaining device. The three-dimensional position measuring device obtains data of three-dimensional coordinates of the object as the point cloud data by emitting laser light on the object and scanning and by measuring light that is reflected at the object. The stereoscopic image information obtaining device obtains stereoscopic image information by using plural imaging devices and obtains data of three-dimensional coordinates of the object as the point cloud data, based on the stereoscopic image information. The three-dimensional laser scanner and the stereoscopic image information obtaining device will be described in the Second Embodiment and the Third Embodiment, respectively.

The point cloud data processing device 100 shown in FIG. 1 is programmed in a notebook size personal computer. That is, the personal computer, in which dedicated software for processing point clouds using the present invention is installed, functions as the point cloud data processing device in FIG. 1. This program does not have to be installed in the personal computer, and it may be stored in a server or an appropriate recording medium and may be provided therefrom.

The personal computer to be used is equipped with an input unit, a display unit such as a liquid crystal display, a GUI (Graphical User Interface) function unit, a CPU and the other dedicated processing units, a semiconductor memory, a hard disk, a disk drive, an interface unit, and a communication interface unit, as necessary. The input unit may be a keyboard, a touchscreen, or the like. The GUI function unit is a user interface for combining the input unit and the display unit. The disk drive transfers information with a storage media such as an optical disk or the like. The interface unit transfers information with a portable storage media such as a USB memory or the like. The communication interface unit performs wireless communication or wired communication. The personal computer is not limited to the notebook size type and may be in another form such as a portable type, a desktop type, or the like. Instead of using a general-purpose personal computer, the point cloud data processing device 100 may be formed of dedicated hardware using an ASIC (Application Specific Integrated Circuit), a PLD (Programmable Logic Device) such as a FPGA (Field Programmable Gate Array), or the like.

### (A) Structure Relating to Calculation of Contour

First, a structure for processing calculation of a contour in the point cloud data processing device 100 will be described. The point cloud data processing device 100 is equipped with a non-plane area removing unit 101, a plane labeling unit 102, and a contour calculating unit 103. Each of these function units will be described hereinafter.

### A1: Non-plane Area Removing Unit

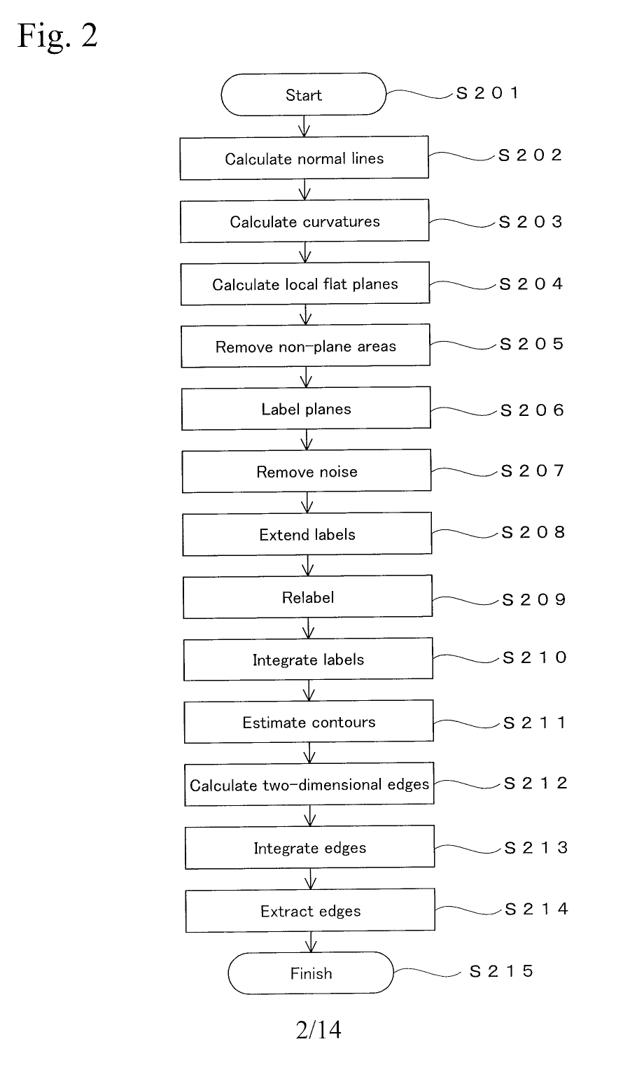

FIG. 2 is a flow chart showing an example of processing that is performed in the point cloud data processing device 100. FIG. 2 shows steps S202 to S204 that are processed by the non-plane area removing unit 101. The non-plane area removing unit 101 includes a local area obtaining unit 101a, a normal vector calculating unit 101b, a local curvature calculating unit 101c, and a local flat plane calculating unit 101d. The local area obtaining unit 101a obtains a local area. The normal vector calculating unit 101b calculates a normal vector of a local area. The local curvature calculating unit 101c calculates a local curvature of the local area. The local flat plane calculating unit 101d calculates a local flat plane that fits to the local area. These function units will be described hereinafter according to the flow of processing.

The local area obtaining unit 101a obtains a square area (grid-like area) of approximately 3 to 7 pixels on a side, which has a target point at the center, as a local area, based on the point cloud data. The normal vector calculating unit 101b calculates a normal vector of each of the points in the local area that is obtained by the local area obtaining unit 101a (step S202). In the calculation of the normal vector, point cloud data of the local area is used, and a normal vector of each point is calculated. This calculation is performed on the entirety of the point cloud data. That is, the point cloud data is segmented into numerous local areas, and a normal vector of each point in each of the local areas is calculated.

The local curvature calculating unit 101c calculates a variation (local curvature) of the normal vectors in the local area (step S203). In this case, in a target local area, an average (mNVx, mNVy, mNVz) of intensity values (NVx, NVy, NVz) of the three axis components of each normal vector is calculated. In addition, a standard deviation (StdNVx, StdNVy, StdNVz) is calculated. Then, a square-root of a sum of squares of the standard deviation is calculated as a local curvature (crv) (see the following First Formula).

Local Curvature=(StdNVx²+StdNVy²+StdNVz²)^{1/2} First Formula

The local flat plane calculating unit 101d is an example of the local space obtaining unit and calculates a local flat plane (two-dimensional local space) that fits (approximates) to the local area (step S204). In this calculation, an equation of a local flat plane is obtained from three-dimensional coordinates of each point in a target local area (local flat plane fitting). The local flat plane is made so as to fit to the target local area. In this case, the equation of the local flat plane that fits to the target local area is obtained by the least-squares method. Specifically, plural equations of different flat planes are obtained and are compared, whereby the equation of the local flat plane that fits to the target local area is obtained. If the target local area is a flat plane, a local flat plane coincides with the local area.

The calculation is repeated so as to be performed on the entirety of the point cloud data by sequentially forming a local area, whereby normal vectors, a local flat plane, and a local curvature, of each of the local areas are obtained.

Next, points of non-plane areas are removed based on the normal vectors, the local flat plane, and the local curvature, of each of the local areas (step S205). That is, in order to extract planes (flat planes and curved planes), portions (non-plane areas), which can be preliminarily identified as non-planes, are removed. The non-plane areas are areas other than the flat planes and the curved planes, but there may be cases in which curved planes with high curvatures are included according to threshold values of the following methods (1) to (3).

The removal of the non-plane areas is performed by at least one of the following three methods. In this embodiment, evaluations according to the following methods (1) to (3) are performed on all of the local areas. If the local area is identified as a non-plane area by at least one of the three methods, the local area is extracted as a local area that forms a non-plane area. Then, point cloud data relating to points that form the extracted non-plane area are removed.

(1) Portion with High Local Curvature

The local curvature that is calculated in the step S203 is compared with a predetermined threshold value, and a local area having a local curvature that exceeds the threshold value is identified as a non-plane area. The local curvature indicates variation of normal vectors of the target point and surrounding points. Therefore, the local curvature is small with respect to planes (flat planes and curved planes with small curvatures), whereas the local curvature is large with respect to areas other than the planes (non-planes). Accordingly, when the local curvature is greater than the predetermined threshold value, the target local area is identified as a non-plane area.

### (2) Fitting Accuracy of Local Flat Plane

Distances between each point in a target local area and a corresponding local flat plane are calculated. When an average of these distances is greater than a predetermined threshold value, the target local area is identified as a non-plane area. That is, when a target local area differs from the shape of a flat plane, and the difference is greater, the distances between each point in the target local area and the corresponding local flat plane are greater. By using this function, degree of non-planarity of a target local area is evaluated.

### (3) Check of Coplanarity

The directions of local flat planes that correspond to adjacent local areas are compared. When the difference in the directions of the local flat planes exceeds a threshold value, the adjacent local areas are identified as non-plane areas. Specifically, two local flat planes that fit to two target local areas, respectively, have a normal vector and a connecting vector that connects center points in the local flat planes. When inner products of each of the normal vectors and the connecting vector are zero, both of the local flat planes are determined to exist in the same plane. When the inner products are greater, the two local flat planes are more separated and are not in the same plane.

A local area that is identified as a non-plane area by at least one of the three methods (1) to (3) is extracted as a local area which forms a non-plane area. Then, point cloud data relating to points that form the extracted local area are removed from point cloud data to be calculated. As described above, non-plane areas are removed in the step S205 in FIG. 2. Thus, point cloud data of non-plane areas are removed from the point cloud data input in the point cloud data processing device 100 by the non-plane area removing unit 101. Since the removed point cloud data may be used in later steps, these point cloud data may be stored in an appropriate storage area or may be set so as to be identified from the remaining point cloud data, in order to make them available later.

### A2: Plane Labeling Unit

Next, function of the plane labeling unit 102 will be described with reference to FIG. 2. The plane labeling unit 102 executes processing of steps S206 to S210 in FIG. 2 with respect to the point cloud data that are processed by the non-plane area removing unit 101.

The plane labeling unit 102 performs plane labeling on the point cloud data, in which the point cloud data of the non-plane areas are removed by the non-plane area removing unit 101, based on continuity of normal vectors (step S206). Specifically, when an angle difference of normal vectors of a target point and an adjacent point is not more than a predetermined threshold value, identical labels are added to these points. By repeating this processing, identical labels are added to each of connected flat planes and connected curved planes with small curvatures, whereby each of the connected flat planes and the connected curved planes are made identifiable as one plane. After the plane labeling is performed in the step S206, whether the label (plane) is a flat plane or a curved plane with a small curvature is evaluated by using the angular difference of the normal vectors and standard deviations of the three axial components of the normal vectors. Then, identifying data for identifying the result of this evaluation are linked to each of the labels.

Labels (planes) with small areas are removed as noise (step S207). The removal of noise may be performed at the same time as the plane labeling in the step S206. In this case, while the plane labeling is performed, the number of the identical labels (number of points forming the identical label) is counted, and labels that have points at not more than a predetermined number are cancelled. Then, a label of the nearest plane is added to the points with no label at this time. Accordingly, the labeled planes are extended (step S208).

The detail of the processing of the step S207 will be described as follows. First, an equation of a labeled plane is obtained, and a distance between the labeled plane and a point with no label is calculated. When there are plural labels (planes) around the point with no label, a label having a smallest distance from the point is selected. If points with no label still exist, each of the threshold values in the removal of non-plane areas (step S205), the removal of noise (step S207), and the extension of label (step S208), is changed, and related processing (relabeling) is performed again (step S209). For example, by increasing the threshold value of the local curvature in the removal of non-plane areas (step S205), fewer points are extracted as non-planes. In another case, by increasing the threshold value of the distance between the point with no label and the nearest plane in the extension of label (step S208), labels are added to more of the points with no label.

When planes have different labels but are in the same planes, the labels of the planes are integrated (step S210). That is, identical labels are added to planes that have the same position or the same direction, even if the planes are not continuous planes. Specifically, by comparing the positions and the directions of the normal vectors of each plane, discontinuous same planes are extracted, and the labels thereof are integrated into one of the labels thereof. These are the function of the plane labeling unit 102.

According to the function of the plane labeling unit 102, the amount of data to be dealt with is compacted, whereby the point cloud data is processed at higher speed. In addition, the amount of necessary memory is decreased. Moreover, point cloud data of passersby and passing vehicles during taking of point cloud data of an object are removed as noise.

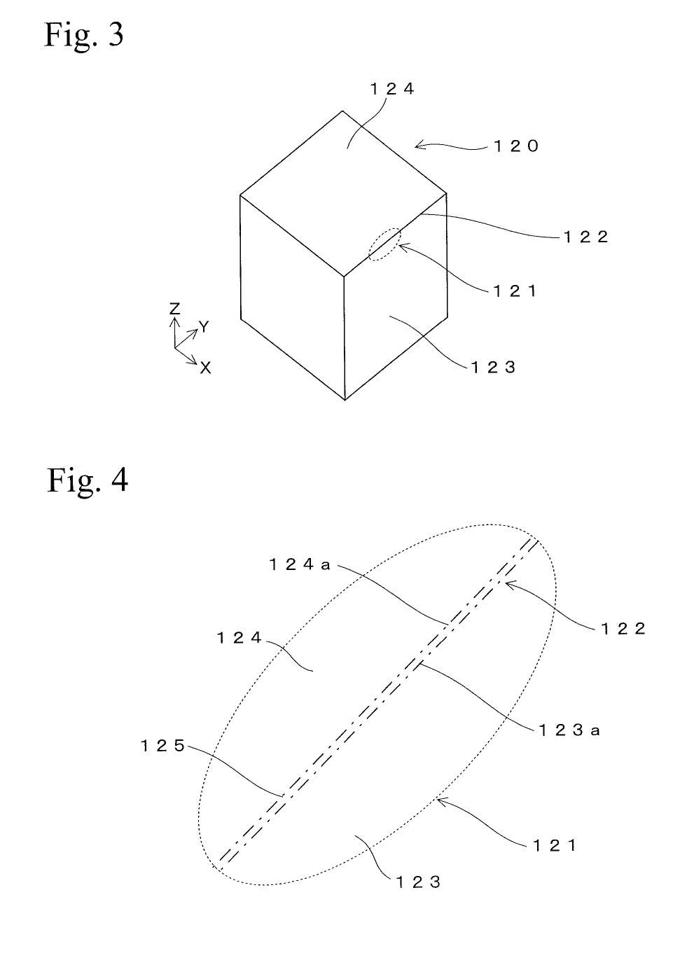

An example of a displayed image based on the point cloud data that are processed by the plane labeling unit 102 will be described as follows. FIG. 3 shows a cube 120 as an example of an object. In this case, the cube 120 is obliquely downwardly scanned with a three-dimensional laser scanner, and point cloud data of the cube 120 is obtained. When this point cloud data is processed in the steps S201 to S210 in FIG. 2, three planes shown in FIG. 3 are labeled, and image data is obtained. The image data is apparently similar to the image shown in FIG. 3 when viewed from a distance.

However, when the vicinity of a boundary between a flat plane 123 and a flat plane 124 is enlarged, an outer edge 123a on the flat plane 124 side of the flat plane 123 and an outer edge 124a on the flat plane 123 side of the flat plane 124 do not coincide with each other and extend approximately parallel as shown in FIG. 4. That is, a contour 122 of the cube 120 is not correctly reproduced.

This is because data of the portion of the contour 122 is for an edge portion at a boundary portion between the flat planes 123 and 124 that form the cube 120, and this data is removed from the point cloud data as a non-plane area 125. Since the flat planes 123 and 124 are labeled and have a different label, point cloud data of the outer edge 123a of an outside edge of the flat plane 123 and the outer edge 124a of an outside edge of the flat plane 124 are processed. Therefore, the outer edges 123a and 124a are displayed. On the other hand, there is no point cloud data of the portion (non-plane area 125) between the outer edges 123a and 124a, whereby image information relating to the non-plane area 125 is not displayed.

For this reason, when the image is displayed based on the output of the plane labeling unit 102, the contour 122 of the boundary between the flat planes 123 and 124 is not correctly displayed. In this regard, in this embodiment, the point cloud data processing device 100 is equipped with the following contour calculating unit 103 so as to output point cloud data of, for example, the contour 122 in the above example.

### A3: Contour Calculating Unit

The contour calculating unit 103 calculates (estimates) a contour based on point cloud data of adjacent planes (step S211 in FIG. 2). A specific calculation method will be described hereinafter.

### First Calculation Method

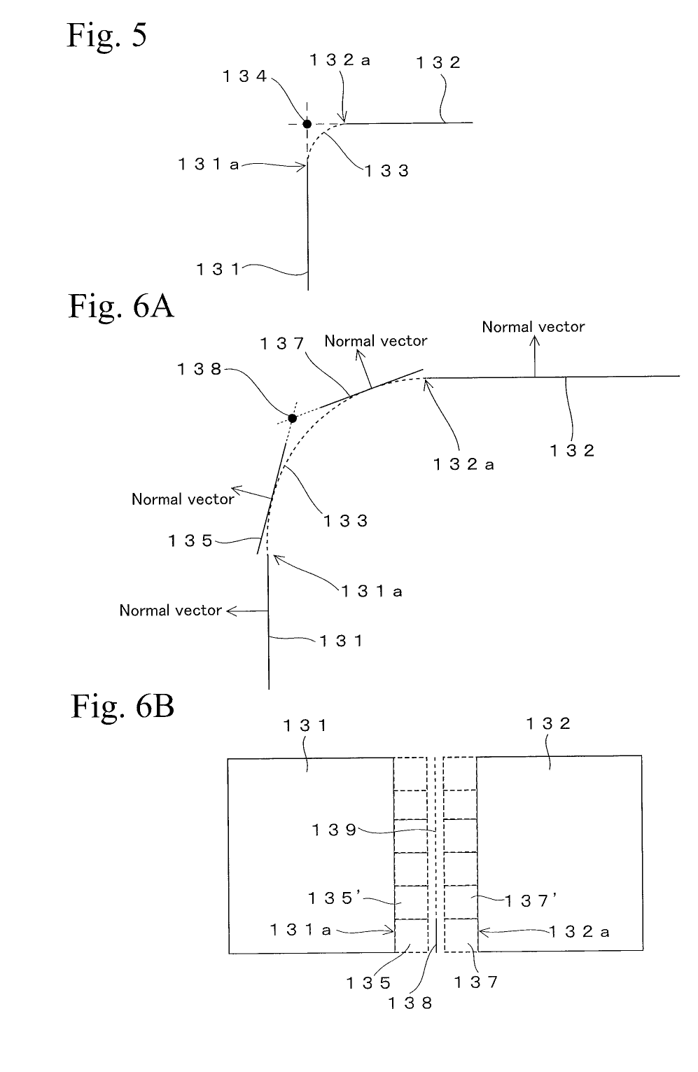

FIG. 5 shows one of functions of a method for calculating a contour. FIG. 5 conceptually shows the vicinity of a boundary between a flat plane 131 and a flat plane 132. In this case, a non-plane area 133 with a small curvature is removed in the removal of non-plane areas, and the adjacent flat planes 131 and 132 are labeled as planes. The flat plane 131 has an outer edge 131a on the flat plane side 132, and the flat plane 132 has an outer edge 132a on the flat plane 131 side. Since point cloud data of a portion between the outer edges 131a and 132a is removed as a non-plane area, data of a contour that exists in the non-plane area 133 are not directly obtained from the point cloud data.

In this regard, in this example, the following processing is performed by the contour calculating unit 103. First, the flat planes 132 and 131 are extended, and a line 134 of intersection thereof is calculated. The line 134 of the intersection is used as a contour that is estimated. The portion which extends from the flat plane 131 to the line 134 of the intersection, and the portion which extends from the flat plane 132 to the line 134 of the intersection, form a polyhedron. The polyhedron is an approximate connecting plane that connects the flat planes 131 and 132. When the flat planes 131 and 132 are curved planes, flat planes having normal vectors of portions at the outer edges 131a and 132a are assumed and are extended, whereby the line 134 of the intersection is calculated.

This method enables easy calculation compared with other methods and is appropriate for high-speed processing. On the other hand, a distance between an actual non-plane area and a calculated contour tends to be large, and there is a high probability of generating a large margin of error. Nevertheless, when an edge is sharp or a non-plane area has a small width, the margin of error is small, whereby the advantage of short processing time is utilized.

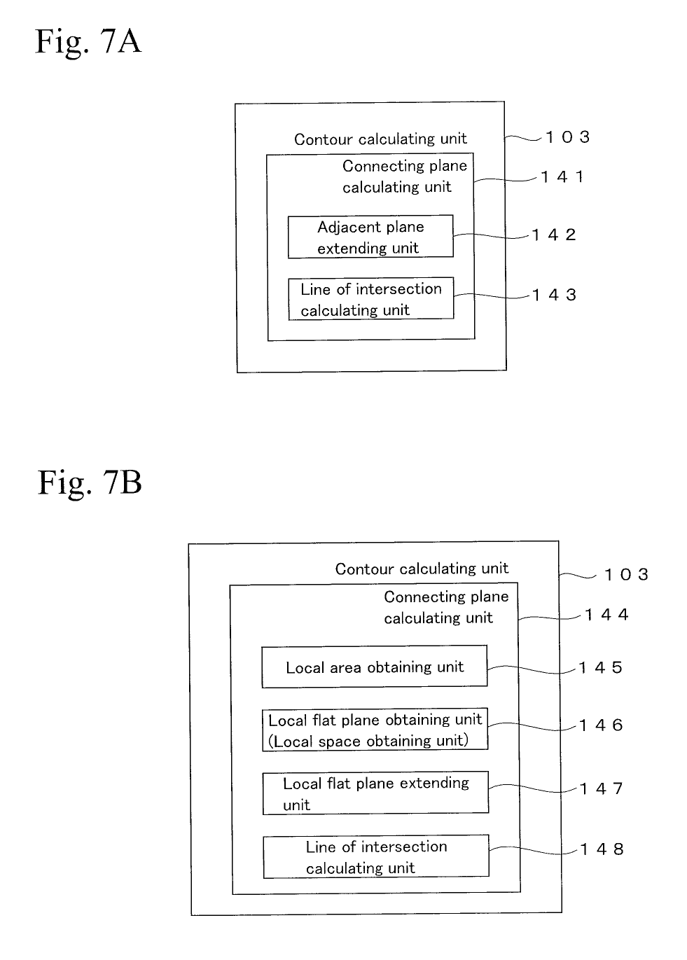

A structure of the contour calculating unit 103 in FIG. 1 for performing the first calculation method is shown in FIG. 7A. In this case, the contour calculating unit 103 includes a connecting plane calculating unit 141 that has an adjacent plane extending unit 142 and a line of intersection calculating unit 143. The adjacent plane extending unit 142 extends a first plane and a second plane that are adjacent to each other. The line of intersection calculating unit 143 calculates a line of intersection of the first plane and the second plane that are extended.

### Second Calculation Method

FIGS. 6A and 6B shows a function of a method for calculating a contour. FIG. 6A shows a conceptual diagram viewed from a direction of a cross section that is obtained by perpendicularly cutting the planes shown in FIG. 5. FIG. 6B shows a conceptual diagram (model figure) of an overview of the two planes and a contour therebetween. FIGS. 6A and 6B conceptually show the vicinity of a boundary between the flat planes 131 and 132 as in the case shown in FIG. 5. In this case, the non-plane area 133 with the small curvature is removed in the removal of non-plane areas, and the adjacent flat planes 131 and 132 are labeled as planes as in the case shown in FIG. 5.

An example of processing will be described hereinafter. First, a local area, which includes a point of the outer edge 131a on the flat plane 132 side of the flat plane 131 and is located on the flat plane 132 side, is obtained. The local area shares the outer edge 131a of the flat plane 131 at an edge portion thereof and is a local square area that forms a part of the non-plane area 133, such as an area of 3×3 points or 5×5 points. The local area shares the outer edge 131a of the flat plane 131 at the edge portion thereof and is thereby connected with the flat plane 131. Then, a local flat plane 135 that fits to this local area is obtained. The local flat plane 135 is affected primarily by the shape of the non-plane area 133, and a direction of a normal vector thereof (direction of the plane) differs from directions of normal vectors of the flat planes 131 and 132 (directions of the planes). The local flat plane is calculated by the same method as in the local flat plane calculating unit 101d.

Next, a local area, which includes a point of the outer edge 132a on the flat plane 131 side of the flat plane 132 and is located on the flat plane 131 side, is obtained. Then, a local flat plane 137 that fits to this local area is obtained. When there is a space for setting more local flat planes between the local flat planes 135 and 137 (or it is necessary to set more local flat planes in order to increase accuracy), the same processing is repeated. Thus, local flat planes are fitted to the local area in the non-plane area 133 from the flat plane 131 side toward the flat plane 132 side and from the flat plane 132 side toward the flat plane 131 side. That is, the non-plane area 133 is approximated by a polyhedron by connecting the local flat planes.

In this example, the distance between the local flat planes 135 and 137 is not more than a threshold value and is identified as a space in which more local flat planes need not be set. Therefore, a line of intersection of the local flat planes 135 and 137, which are close and adjacent to each other, is obtained, and a contour 138 is calculated. The local flat plane 135, the local flat plane 137, and each portion that extends from the local flat plane 135 or 137 to the line of the intersection, form a polyhedron. The polyhedron is an approximate connecting plane that connects the flat planes 131 and 132. According to this method, the connecting plane that connects the flat planes 131 and 132 is formed by connecting the local flat planes that fit to the non-plane area. Therefore, the calculation accuracy of the contour is more increased compared with the case shown in FIG. 5.

Thus, as shown in FIG. 6B, the contour 138 (line element of contour) having a similar length to the local flat planes 135 and 137 is obtained. By performing this processing along the extending direction of the non-plane area, a contour 139 that segments the flat planes 131 and 132 is calculated. Specifically, after the contour 138 shown in FIG. 6A is calculated, local flat planes 135′ and 137′ are obtained by the same method, and a portion of a contour therebetween is calculated. By repeating this processing, the short contour 138 is extended, and the contour 139 is obtained.

An example of further setting local flat planes on the flat plane 132 side of the local flat plane 135 will be described hereinafter. First, a local area, which includes a point of an edge on the flat plane 132 side of the local area that is a base of the local flat plane 135, is obtained. This local area is located on the flat plane 132 side. In addition, a local flat plane that fits to this local area is obtained. This processing is also performed on the flat plane 132 side. This processing is repeated on each of the flat plane sides, and the local flat planes are connected, whereby a connecting plane is formed. When a space between two local flat planes, which face and are close to each other, becomes not more than the threshold value, a line of intersection of the two local flat planes is calculated and is obtained as a contour.

The plural local areas that are sequentially obtained from the first plane toward the second plane share some points with the adjacent first plane or adjacent local areas. Therefore, each of the plural local areas is connected with the first plane. That is, a local area that is separated from the first plane is used as a local area that is connected with the first plane as long as the local area is obtained according to the above-described processing. Although each of adjacent local flat planes fits to the connected local area, the adjacent local flat planes differ from each other in direction depending on the shape of the non-plane area. Accordingly, there may be cases in which the local flat planes are not completely connected, and a polyhedron including openings may be formed in a precise sense. However, the openings are ignored and used as connecting planes for the structure of the polyhedron in this example.

A structure of the contour calculating unit 103 in FIG. 1 for performing the second calculation method is shown in FIG. 7B. In this case, the contour calculating unit 103 includes a connecting plane calculating unit 144. The connecting plane calculating unit 144 includes a local area obtaining unit 145, a local flat plane obtaining unit 146, a local flat plane extending unit 147, and a line of intersection calculating unit 148. The local area obtaining unit 145 obtains local areas that are necessary for obtaining the local flat planes 135 and 137. The local flat plane obtaining unit 146 is an example of the local space obtaining unit and obtains local flat planes that fit to the local areas obtained by the local area obtaining unit 145. The local flat plane extending unit 147 extends a local flat plane (local flat plane 135 in the case shown in FIGS. 6A and 6B), which is extended from the flat plane 131 toward the flat plane 132. In addition, the local flat plane extending unit 147 extends a local flat plane (local flat plane 137 in the case shown in FIGS. 6A and 6B), which is extended from the flat plane 132 toward the flat plane 131. The line of intersection calculating unit 148 calculates a line of intersection of the local flat planes that are extended.

According to this method, a space (portion of the non-plane area) between the first plane and the second plane, which are adjacent to each other via the non-plane area, is connected with the local flat planes. After the space is gradually narrowed until the space is sufficiently small, a line of intersection of the local flat planes, which are adjacent to each other via the space, is calculated and is obtained as a contour. As a standard for evaluating whether more local flat planes are required between the local flat planes 135 and 137, a difference in the direction of the normal vectors of the local flat planes 135 and 137 may be used. In this case, if the difference in the direction of the normal vectors of the local flat planes 135 and 137 is not more than a threshold value, it is determined that the contour is to be calculated at high accuracy by using the line of intersection of the local flat planes 135 and 137. Therefore, more local flat planes are not obtained, and a contour is calculated based on the line of the intersection of the local flat planes 135 and 137 as in the case shown in FIGS. 6A and 6B.

### Third Calculation Method

In this method, the removal of non-plane areas and the plane labeling are performed again by changing the threshold value with respect to the area that is identified as a non-plane area in the initial processing. As a result, a more limited non-plane area is removed, and a contour is then calculated by using one of the first calculation method and the second calculation method again.

The non-plane area to be removed may be further narrowed by changing the threshold value two or three times and recalculating, in order to increase the accuracy. In this case, if the repeated number of the calculation is increased by changing the threshold value, the calculation time is increased. Therefore, it is desirable to set an appropriate threshold value for the number of change of the threshold value so that the processing is advanced to the calculation of the contour by the other calculation method when the recalculation is performed some times.

### Fourth Calculation Method

A method of using a local straight line (one-dimensional local space) instead of the local flat plane may be used in a similar manner as in the case of the second calculation method. In this case, the local flat plane calculating unit 101d in FIG. 1 functions as a local straight line calculating unit that is a local space obtaining unit for obtaining one-dimensional local space. This method will be described with reference to FIGS. 6A and 6B hereinafter. In the conceptual diagram in FIGS. 6A and 6B, the portions indicated by the reference numerals 135 and 137 are used as local straight lines. The local straight line is obtained by narrowing the local flat plane so as to have a width of one point (there is no width in mathematical terms). This method is performed in the same manner as in the case of the local flat plane. First, a local area that connects with the flat plane 131 is obtained, and a local straight line, which fits to this local area and extends toward the flat plane 132, is calculated. Then, a connecting line (in this case, not a plane but a line) that connects the flat planes 131 and 132 is formed by the local straight line.

The local straight line is calculated as in the case of the local flat plane, and it is obtained by calculating an equation of a line, which fits to a target local area, using the least-squares method. Specifically, plural equations of different straight lines are obtained and compared, and an equation of a straight line that fits to the target local area is obtained. If the target local area is a flat plane, a local straight line and the local area are parallel. Since the local area, to which a local straight line is fitted, is a local area that forms a part of the non-plane area 133, the local straight line (in this case, the reference numeral 135) is not parallel to the flat planes 131 and 132.

The same processing is also performed on the plane 132 side, and a local straight line that is indicated by the reference numeral 137 is calculated. Then, an intersection point (in this case, the reference numeral 138) of the two local straight lines is obtained as a contour passing point. The actual contour is calculated by obtaining plural intersection points and connecting them. The contour may be calculated by obtaining intersection points of local straight lines at adjacent portions and by connecting them. On the other hand, the contour may be calculated by obtaining plural intersection points of local straight lines at portions at plural point intervals and by connecting them.

Moreover, the contour may be calculated by setting plural local straight lines at smaller local areas so as to form a connecting line made of shorter local straight lines. This method is the same as in the case of the calculation of the contour using the local flat planes, which is described in the second calculation method.

### Another Calculation Method

As another method for estimating a contour by calculating a line of intersection of local flat planes, a method of setting a contour at a center portion of a connecting plane may be described. In this case, one of the following methods may be used for calculating a center portion of a connecting plane. That is, (1) a method of using a center portion of a connecting plane may be used by assuming that a contour passes therethrough, whereby a contour is calculated. On the other hand, (2) a method of using a center point of a local plane, which has a normal line at (or close to) the middle of a variation range of normal lines of local planes (change of direction of planes), as a contour passing point, may be used. Alternatively, (3) a method of using a portion, which has a largest rate of change of normal lines of local planes (change of direction of planes), as a contour passing point, may be used. As the local plane, a local curved plane may be used. In this case, a curved plane that is easy to use as data is selected and is used instead of the local flat plane. On the other hand, a method of preparing plural kinds of local planes and selecting a local plane that fits closely to the local area therefrom, may be used.

### Example of Contour

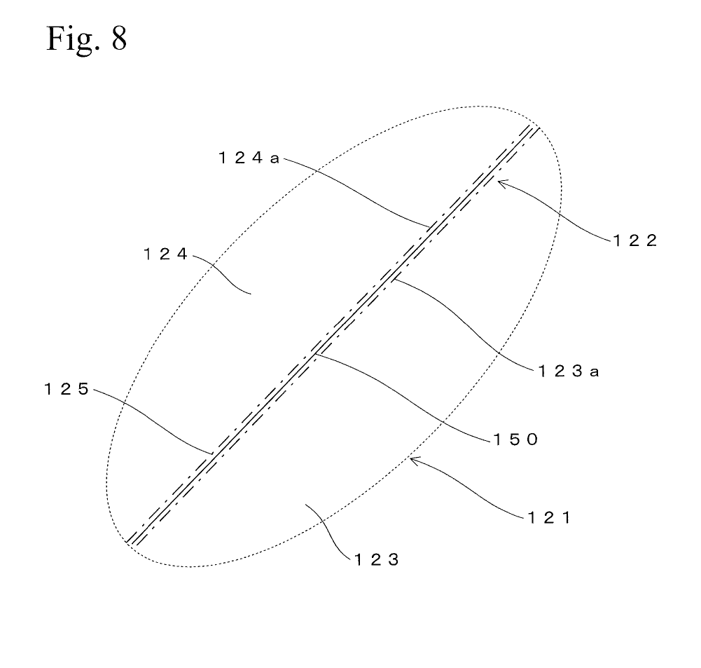

An example of a calculated contour will be described as follows. FIG. 8 is a conceptual diagram corresponding to FIG. 4. FIG. 8 shows a case in which a contour 150 is calculated by the calculation of contour (the second calculation method) as described in this embodiment in the condition shown in FIG. 4. In this case, in the area which is removed as the non-plane area, a connecting plane that connects the labeled flat planes 123 and 124 is calculated based on the outer edge 123a of the flat plane 123 and the outer edge 124a of the flat plane 124 by the second calculation method (see FIGS. 6A and 6B). Then, a line of intersection of two local flat planes that form the connecting plane is obtained, whereby the contour 150 is calculated. By calculating the contour 150, the indistinct image of the outline of the object (in this case, the cube 120) in FIG. 3 is clarified. Accordingly, by taking the data of the contour in three-dimensional CAD data, an image data suitable to be used as CAD data is obtained from the point cloud data.

### A4: Two-dimensional Edge Calculating Unit

Next, a two-dimensional edge calculating unit 104 in FIG. 1 will be described hereinafter. The two-dimensional edge calculating unit 104 performs processing of step S212 in FIG. 2, and an example of the processing is described as follows. First, a provisional edge is extracted from within a two-dimensional image that corresponds to the segmented plane, based on intensity distribution of light that is reflected at the object, by using a publicly-known edge extracting operator such as a Laplacian, Prewitt, Sobel, or Canny. Since a two-dimensional edge is identified by difference in the contrasting density within a plane, the difference in the contrasting density is extracted from the intensity information of the light that is reflected. Therefore, by setting a threshold value for the condition of the extraction, a boundary between portions having different contrasting density is extracted as the provisional edge. Then, a height (z value) of three-dimensional coordinates of a point that forms the extracted provisional edge, and a height (z value) of three-dimensional coordinates of a point that forms a contour (three-dimensional edge) in the vicinity of the provisional edge, are compared. When the difference of these heights is not more than a predetermined threshold value, the provisional edge is identified as a two-dimensional edge. That is, whether the point that forms the provisional edge, which is extracted in the two-dimensional image, is on a segmented plane or not is evaluated. Then, if the point is determined to be on the segmented plane, the provisional edge is identified as a two-dimensional edge.

After the two-dimensional edge is calculated (step S212), the contours that are calculated by the contour calculating unit 103, and the two-dimensional edges that are calculated by the two-dimensional edge calculating unit 104, are integrated. Thus, edges are extracted based on the point cloud data (S214). By extracting edges, lines that form the appearance of the object are extracted. Accordingly, data of a line figure of the object is obtained. For example, a case of selecting a building as the object will be described as follows. In this case, data of a line figure is obtained based on point cloud data of the building by the processing in FIG. 2. The appearance of the building, figures on exterior walls, and contours of windows and the like are represented by the data of the line figure. Edges of portions with relatively little projection and recess, such as a window, may be processed as contours or processed as two-dimensional edges, depending on the evaluations using the threshold values. Such data of the line figure may be used as three-dimensional CAD data or a data for a draft of the object.

### (B) First Structure Relating to Processing for Requesting Remeasurement of Point Cloud Data

The point cloud data processing device 100 is equipped with the point cloud data remeasurement request processing unit 106 as a structure relating to processing for requesting remeasurement of the point cloud data. The point cloud data remeasurement request processing unit 106 performs processing relating to request for remeasurement of the point cloud data based on at least one of results of the processing performed by the non-plane area removing unit 101, the plane labeling unit 102, and the contour calculating unit 103. The processing that is performed by the point cloud data remeasurement request processing unit 106 will be described hereinafter.

### First Processing

The point cloud data remeasurement request processing unit 106 performs processing so as to remeasure the point cloud data of areas that are processed as non-plane areas by the non-plane area removing unit 101. That is, the point cloud data remeasurement request processing unit 106 requests remeasurement of the point cloud data of the non-plane areas. An example of this processing will be described as follows. First, the density of point cloud data to be initially obtained is set so as to be relatively rough. Then, remeasurement of the point cloud data of portions (non-plane areas) other than the portions, which are labeled as planes in the initial processing, is requested. Thus, while the point cloud data is efficiently obtained, the calculation accuracy is increased. In this processing, the density of point cloud data may be set at plural levels, and the point cloud data may be repeatedly obtained, whereby point cloud data with higher density are obtained in areas with larger non-planarity in stages. That is, a method of gradually narrowing areas of which point cloud data need to be remeasured at higher density may be used.

### Second Processing

The point cloud data remeasurement request processing unit 106 performs processing for remeasuring the point cloud data of the contours and the vicinities thereof based on result of the processing performed by the contour calculating unit 103. In this case, remeasurement of the point cloud data of the portions of the contours and the surroundings thereof is requested. For example, an area with a width of 4 to 10 measured points may be remeasured. According to this processing, image data of contours with higher accuracy are obtained. In addition, portions of two-dimensional edges and the surroundings thereof may be selected for the remeasurement of the point cloud data in addition to the contours.

### Third Processing

The point cloud data remeasurement request processing unit 106 performs processing for remeasuring the point cloud data of portions at which fitting accuracy of planes are low, based on result of the processing performed by the plane labeling unit 102. In this case, the fitting accuracy of labeled planes are evaluated by a threshold value, and remeasurement of the point cloud data of planes, which are determined to have a low fitting accuracy, is requested.

### Fourth Processing

Errors tend to occur especially in non-plane areas that are generated by occlusion, such as three-dimensional edges. The point cloud data remeasurement request processing unit 106 extracts such areas by evaluating the fitting accuracy of the local flat planes and the coplanarity and performs processing for remeasuring the point cloud data of the areas. In this case, the processing relating to request for remeasurement of the point cloud data is performed based on result of the processing performed by the non-plane area removing unit 101.

### Fifth Processing

There may be cases in which a space is generated because the plane labeling and the calculation of contour are not performed for some reasons. For example, this problem tends to occur at portions of occlusion and at portions of the object, which are scanned by light at extremely shallow angle (angle that is approximately parallel to extending direction of a plane or an edge). The point cloud data remeasurement request processing unit 106 detects such areas and performs processing for remeasuring the point cloud data of the areas. The space is detected according to whether the space is labeled, whether the space includes a ridge line, and whether the data of the space is in continuity with the data of the other areas. In this case, the processing relating to request for remeasurement of the point cloud data is performed based on at least one of results of the processing performed by the non-plane area removing unit 101, the plane labeling unit 102, and the contour calculating unit 103.

### Sixth Processing

The point cloud data remeasurement request processing unit 106 evaluates accuracy of the image (image formed of lines: image of a line figure) in which the contours and the two-dimensional edges are integrated by the edge integrating unit 105. In this case, the point cloud data remeasurement request processing unit 106 has a function of an accuracy evaluating unit 106′ as shown in FIG. 1. Specifically, representations that are not appropriate as lines, such as indistinct lines, discontinued lines, and inappropriately bent lines (jagged lines), are detected. In this processing, a reference object is preliminarily selected as a standard and is processed as data, and whether the representations are appropriate or not is evaluated by comparing the representations and the data. In this case, the processing relating to request for remeasurement of the point cloud data is performed based on results of the processing performed by the contour calculating unit 103 and the two-dimensional edge calculating unit 104.

### (C) Second Structure Relating to Processing for Requesting Remeasurement of Point Cloud Data

The point cloud data processing device 100 is also equipped with a point cloud data remeasurement request signal output unit 107, an instruction input device 110, and an input instruction receiving unit 111, as a structure relating to the processing for requesting remeasurement of the point cloud data. The point cloud data remeasurement request signal output unit 107 generates a signal for requesting remeasurement of the point cloud data based on the processing of the point cloud data remeasurement request processing unit 106 and outputs the signal to the outside. For example, according to result of the processing performed by the point cloud data remeasurement request processing unit 106, the point cloud data remeasurement request signal output unit 107 outputs a signal for requesting remeasurement of the point cloud data of a selected area to the three-dimensional laser scanner. The three-dimensional laser scanner is connected with the personal computer that forms the point cloud data processing device 100.

The point cloud data processing device 100 in FIG. 1 is equipped with the instruction input device 110 and the input instruction receiving unit 111. The instruction input device 110 is an input device, by which a user operates the point cloud data processing device 100, and is an operational interface using GUI, for example. The input instruction receiving unit 111 receives instructions that are input by a user and converts the instructions into various control signals.

The operation using the instruction input device 110 will be described hereinafter. In this example, a user can freely select portions (for example, portions with indistinct contours) while the user watches an image display device 109. This operation may be performed by using GUI. The selected portions are highlighted by changing colors or contrasting density so as to be visually understandable.

### (D) Other Structure

The point cloud data processing device 100 is also equipped with a image display controlling unit 108 and the image display device 109. The image display controlling unit 108 controls shift and rotation of a displayed image, switching of displaying images, enlargement and reduction of an image, scrolling, and displaying of an image relating to a publicly-known GUI on the image display device 109. The image display device 109 may be a liquid crystal display, for example. The data of the line figure that is obtained by the edge integrating unit 105 is transmitted to the image display controlling unit 108, and the image display controlling unit 108 displays a figure (a line figure) on the image display device 109 based on the data of the line figure.

### Operation Example

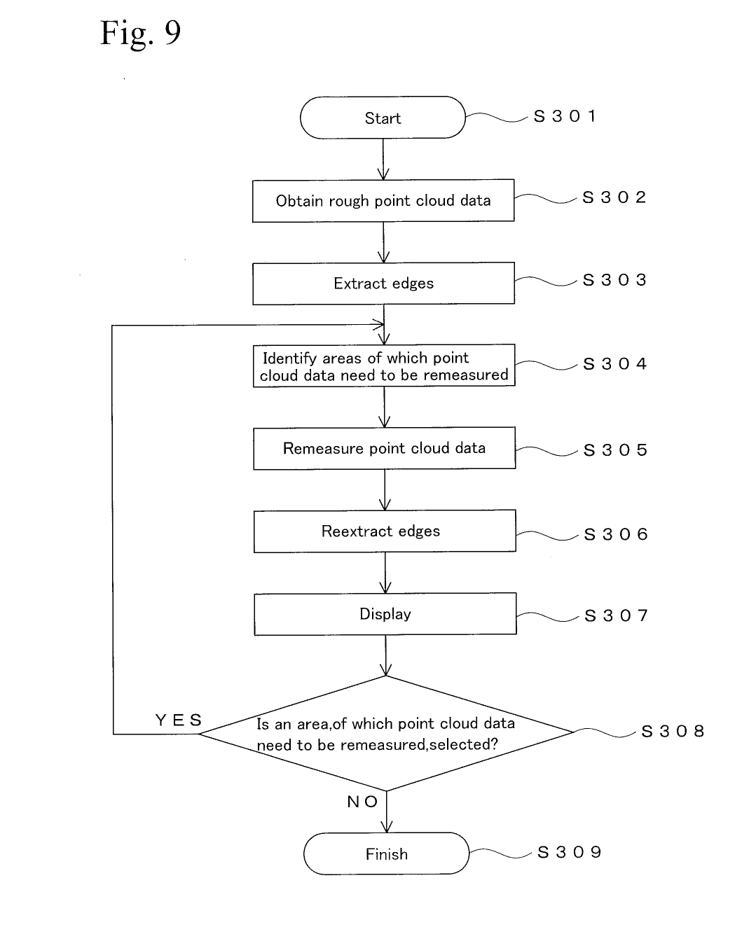

An example of operation of the above-described structures will be described hereinafter. FIG. 9 shows an example of operation that is performed by the point cloud data processing device 100. In this case, the point cloud data processing device 100 is connected with a three-dimensional laser scanner for obtaining point cloud data. When the processing is started (step S301), the three-dimensional laser scanner is requested to obtain rough point cloud data, whereby rough point cloud data is obtained (step S302). The rough point cloud data is obtained in a condition in which the density of measured points (scan density) is set at relatively low. According to this condition, point cloud data is obtained at a density which is sufficient to extract planes but which is slightly insufficient to calculate contours. For the density of the points (scan density) of the rough point cloud data, an experimentally obtained value is used.

After the rough point cloud data is obtained, edges are extracted by performing the processing shown in FIG. 2 (step S303). According to this processing, data of a line figure which is formed of contours and two-dimensional edges are obtained. Then, according to the function of the point cloud data remeasurement request processing unit 106, areas of which point cloud data need to be remeasured are identified (step S304). This identification is performed by using one or a plurality of the processing performed in the point cloud data remeasurement request processing unit 106. If there is no area of which point cloud data need to be remeasured, the processing is advanced to step S307. For example, in a case in which sufficient accuracy is obtained based on the rough point cloud data, there is no area of which point cloud data need to be remeasured. Next, the processing for remeasuring (rescan) the point cloud data of the identified areas is performed, whereby point cloud data is obtained again (step S305). In this case, the point cloud data is remeasured by setting the density of the point cloud data (density of measured points=scan density) so as to be relatively higher than in the case of the step S302.

Then, the processing shown in FIG. 2 is performed again based on the remeasured point cloud data, and edges are reextracted (step S306). Images of the extracted edges (image of a line figure in which contours and two-dimensional edges are integrated) are displayed on the image display device 109 (step S307). At this time, if there is a portion of which point cloud data need to be remeasured when a user watches the displayed image, the portion is selected by using the instruction input device 110 in FIG. 1. In this case, the selection of the area of the portion of which point cloud data need to be remeasured is received in the evaluation in the step S308, and the processing is returned to the stage before the step S304. The area of the object, which is selected by the user, is identified as an area of which point cloud data need to be remeasured (step S304), and the processing of the step S305 and the subsequent processing are performed again. In the step S308, if the user does not instruct remeasurement of the point cloud data, the processing is finished (step S309).

### 2. Second Embodiment

A point cloud data processing device equipped with a three-dimensional laser scanner will be described hereinafter. In this example, the point cloud data processing device emits distance measuring light (laser light) and scans with respect to an object and measures a distance to each of numerous measured points on the object therefrom based on flight time of the laser light. Then, the point cloud data processing device measures the emitted direction (horizontal angle and elevation angle) of the laser light and calculates three-dimensional coordinates of each of the measured points based on the distance and the emitted direction. The point cloud data processing device takes two-dimensional images (RGB intensity of each of the measured points) that are photographs of the object and forms point cloud data by linking the two-dimensional images and the three-dimensional coordinates. Next, the point cloud data processing device generates a line figure, which is formed of contours and shows three-dimensional outlines of the object, from the point cloud data. Moreover, the point cloud data processing device performs remeasurement of the point cloud data, which is described in the First Embodiment.

### Structure

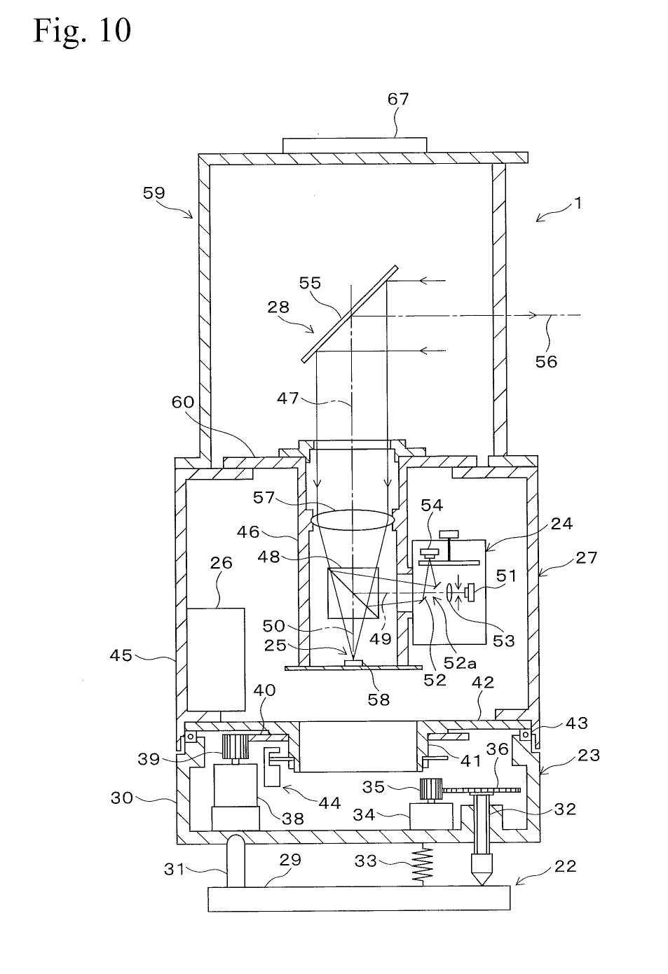

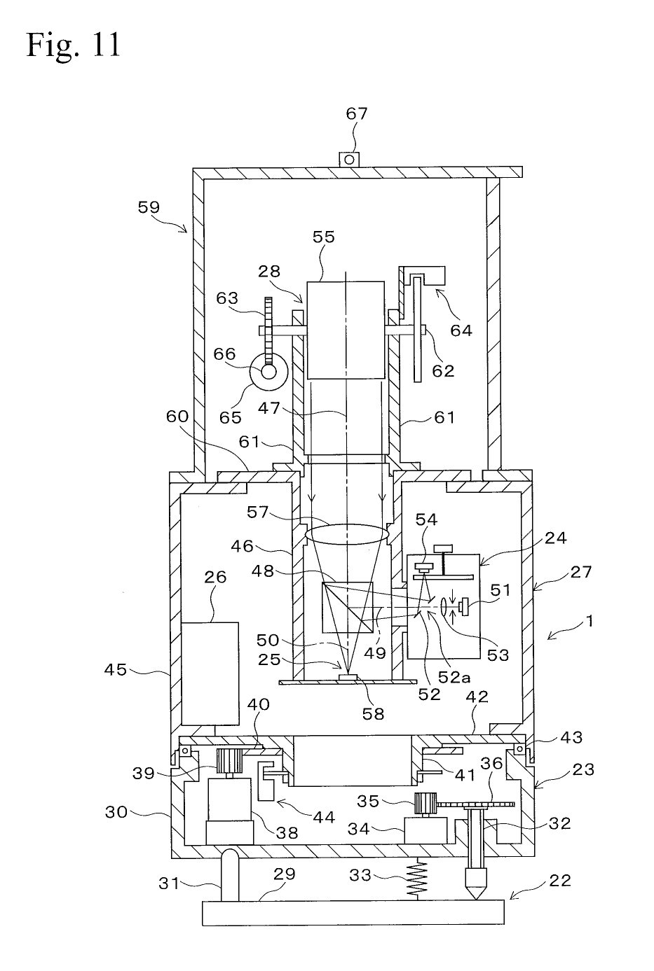

FIGS. 10 and 11 are cross sections showing a structure of a point cloud data processing device 1. The point cloud data processing device 1 is equipped with a level unit 22, a rotational mechanism 23, a main body 27, and a rotationally emitting unit 28. The main body 27 is formed of a distance measuring unit 24, an imaging unit 25, and a controlling unit 26, etc. For convenience of description, FIG. 11 shows the point cloud data processing device 1 in which only the rotationally emitting unit 28 is viewed from a side direction with respect to the cross-section direction shown in FIG. 10.

The level unit 22 has a base plate 29, and the rotational mechanism 23 has a lower casing 30. The lower casing 30 is supported by the base plate 29 with three points of a pin 31 and two adjusting screws 32. The lower casing 30 is tiltable on a fulcrum of a head of the pin 31. An extension spring 33 is provided between the base plate 29 and the lower casing 30 so that they are not separated from each other.

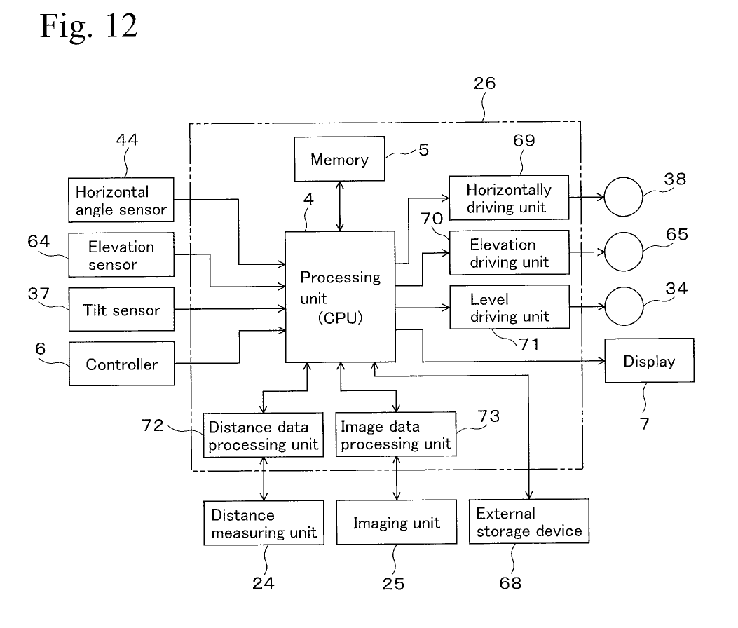

Two level motors 34 are provided inside the lower casing 30. The two level motors 34 are driven independently of each other by the controlling unit 26. By driving the level motors 34, the adjusting screws 32 rotate via a level driving gear 35 and a level driven gear 36, and the downwardly protruded amounts of the adjusting screws 32 are adjusted. Moreover, a tilt sensor 37 (see FIG. 12) is provided inside the lower casing 30. The two level motors 34 are driven by detection signals of the tilt sensor 37, whereby leveling is performed.

The rotational mechanism 23 has a horizontal rotation driving motor 38 inside the lower casing 30. The horizontal rotation driving motor 38 has an output shaft into which a horizontal rotation driving gear 39 is fitted. The horizontal rotation driving gear 39 is engaged with a horizontal rotation gear 40. The horizontal rotation gear 40 is provided to a rotating shaft portion 41. The rotating shaft portion 41 is provided at the center portion of a rotating base 42. The rotating base 42 is provided on the lower casing 30 via a bearing 43.

The rotating shaft portion 41 is provided with, for example, an encoder, as a horizontal angle sensor 44. The horizontal angle sensor 44 measures a relative rotational angle (horizontal angle) of the rotating shaft portion 41 with respect to the lower casing 30. The horizontal angle is input to the controlling unit 26, and the controlling unit 26 controls the horizontal rotation driving motor 38 based on the measured results.

The main body 27 has a main body casing 45. The main body casing 45 is securely fixed to the rotating base 42. A lens tube 46 is provided inside the main body casing 45. The lens tube 46 has a rotation center that is concentric with the rotation center of the main body casing 45. The rotation center of the lens tube 46 corresponds to an optical axis 47. A beam splitter 48 as a means for splitting light flux is provided inside the lens tube 46. The beam splitter 48 transmits visible light and reflects infrared light. The optical axis 47 is split into an optical axis 49 and an optical axis 50 by the beam splitter 48.

The distance measuring unit 24 is provided to the outer peripheral portion of the lens tube 46. The distance measuring unit 24 has a pulse laser light source 51 as a light emitting portion. The pulse laser light source 51 and the beam splitter 48 are provided with a perforated mirror 52 and a beam waist changing optical system 53 therebetween. The beam waist changing optical system 53 changes beam waist diameter of the laser light. The pulse laser light source 51, the beam waist changing optical system 53, and the perforated mirror 52, form a distance measuring light source unit. The perforated mirror 52 introduces the pulse laser light from a hole 52a to the beam splitter 48 and reflects laser light, which is reflected at the object and returns, to a distance measuring-light receiver 54.

The pulse laser light source 51 is controlled by the controlling unit 26 and emits infrared pulse laser light at a predetermined timing accordingly. The infrared pulse laser light is reflected to an elevation adjusting rotating mirror 55 by the beam splitter 48. The elevation adjusting rotating mirror 55 reflects the infrared pulse laser light to the object. The elevation adjusting rotating mirror 55 turns in the elevation direction and thereby converts the optical axis 47 extending in the vertical direction into a floodlight axis 56 in the elevation direction. A focusing lens 57 is arranged between the beam splitter 48 and the elevation adjusting rotating mirror 55 and inside the lens tube 46.

The laser light reflected at the object is guided to the distance measuring-light receiver 54 via the elevation adjusting rotating mirror 55, the focusing lens 57, the beam splitter 48, and the perforated mirror 52. In addition, reference light is also guided to the distance measuring-light receiver 54 through an inner reference light path. Based on a difference between two times, a distance from the point cloud data processing device 1 to the object (measured point) is measured. One of the two times is a time until the laser light is reflected and is received at the distance measuring-light receiver 5, and the other is a time until the laser light is received at the distance measuring-light receiver 54 through the inner reference light path.

The imaging unit 25 has an image sensor 58 that is provided at the bottom of the lens tube 46. The image sensor 58 is formed of a device in which a great number of pixels are flatly assembled and arrayed, for example, a CCD (Charge Coupled Device). The position of each pixel of the image sensor 58 is identified by the optical axis 50. For example, the optical axis 50 may be used as the origin, and an X-Y coordinate is assumed, whereby the pixel is defined as a point on the X-Y coordinate.

The rotationally emitting unit 28 is contained in a floodlight casing 59 in which a part of the circumferential wall is made as a floodlight window. As shown in FIG. 11, the lens tube 46 has a flange portion 60 to which two mirror holding plates 61 are oppositely provided. A rotating shaft 62 is laid between the mirror holding plates 61. The elevation adjusting rotating mirror 55 is fixed to the rotating shaft 62. The rotating shaft 62 has an end into which an elevation gear 63 is fitted. An elevation sensor 64 is provided at the side of the other end of the rotating shaft 62, and it measures rotation angle of the elevation adjusting rotating mirror 55 and outputs the measured results to the controlling unit 26.

One of the mirror holding plates 61 is mounted with an elevation adjusting driving motor 65. The elevation adjusting driving motor 65 has an output shaft into which a driving gear 66 is fitted. The driving gear 66 is engaged with the elevation gear 63 that is mounted to the rotating shaft 62. The elevation adjusting driving motor 65 is controlled by the controlling unit 26 and is thereby appropriately driven based on the results that are measured by the elevation sensor 64.

A bead rear sight 67 is provided on the top of the floodlight casing 59. The bead rear sight 67 is used for approximate collimation with respect to the object. The collimation direction using the bead rear sight 67 is the extending direction of the floodlight axis 56 and is a direction which orthogonally crosses the extending direction of the rotating shaft 62.

FIG. 12 is a block diagram of the controlling unit 26. The controlling unit 26 receives detection signals from the horizontal angle sensor 44, the elevation sensor 64, and the tilt sensor 37. The controlling unit 26 also receives instruction signals from a controller 6. The controlling unit 26 drives and controls the horizontal rotation driving motor 38, the elevation adjusting driving motor 65, and the level motor 34, and also controls a display 7 that displays working condition and measurement results, etc. The controlling unit 26 is removably provided with an external storage device 68 such as a memory card, a HDD, or the like.

The controlling unit 26 is formed of a processing unit 4, a memory 5, a horizontally driving unit 69, an elevation driving unit 70, a level driving unit 71, a distance data processing unit 72, an image data processing unit 73, etc. The memory 5 stores various programs, an integrating and controlling program for these programs, and various data such as measured data, image data, and the like. The programs include sequential programs necessary for measuring distances, elevation angles, and horizontal angles, calculation programs, programs for executing processing of measured data, and image processing programs. The programs also include programs for extracting planes from point cloud data and calculating contours, image display programs for displaying the calculated contours on the display 7, and programs for controlling processing relating to remeasurement of the point cloud data. The horizontally driving unit 69 drives and controls the horizontal rotation driving motor 38. The elevation driving unit 70 drives and controls the elevation adjusting driving motor 65. The level driving unit 71 drives and controls the level motor 34. The distance data processing unit 72 processes distance data that are obtained by the distance measuring unit 24. The image data processing unit 73 processes image data that are obtained by the imaging unit 25.

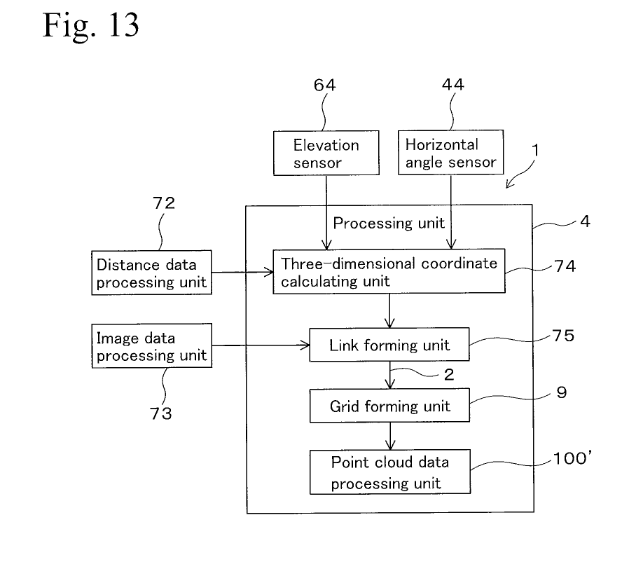

FIG. 13 is a block diagram of the processing unit 4. The processing unit 4 has a three-dimensional coordinate calculating unit 74, a link forming unit 75, a grid forming unit 9, and a point cloud data processing unit 100′. The three-dimensional coordinate calculating unit 74 receives the distance data of the measured points from the distance data processing unit 72 and also receives direction data (horizontal angle and elevation angle) of the measured points from the horizontal angle sensor 44 and the elevation sensor 64. The three-dimensional coordinate calculating unit 74 calculates three-dimensional coordinates (orthogonal coordinates) of each of the measured points having the origin (0, 0, 0) at the position of the point cloud data processing device 1, based on the received distance data and the received direction data.

The link forming unit 75 receives the image data from the image data processing unit 73 and data of three-dimensional coordinates of each of the measured points, which are calculated by the three-dimensional coordinate calculating unit 74. The link forming unit 75 forms point cloud data 2 in which the image data (RGB intensity of each of the measured points) are linked with the three-dimensional coordinates. That is, the link forming unit 75 forms data by linking a position of a measured point of the object in a two-dimensional image with three-dimensional coordinates of the measured point. The linked data are calculated with respect to all of the measured points and thereby form the point cloud data 2.

The point cloud data processing device 1 can acquire point cloud data 2 of the object that are measured from different directions. Therefore, if one measuring direction is represented as one block, the point cloud data 2 may consist of two-dimensional images and three-dimensional coordinates of plural blocks.

The link forming unit 75 outputs the point cloud data 2 to the grid forming unit 9. The grid forming unit 9 forms a grid (meshes) with equal distances and registers the nearest points on the intersection points of the grid when distances between adjacent points of the point cloud data 2 are not constant. Alternatively, the grid forming unit 9 corrects all points to the intersection points of the grid by using a linear interpolation method or a bicubic method. When the distances between the points of the point cloud data 2 are constant, the processing of the grid forming unit 9 may be skipped.

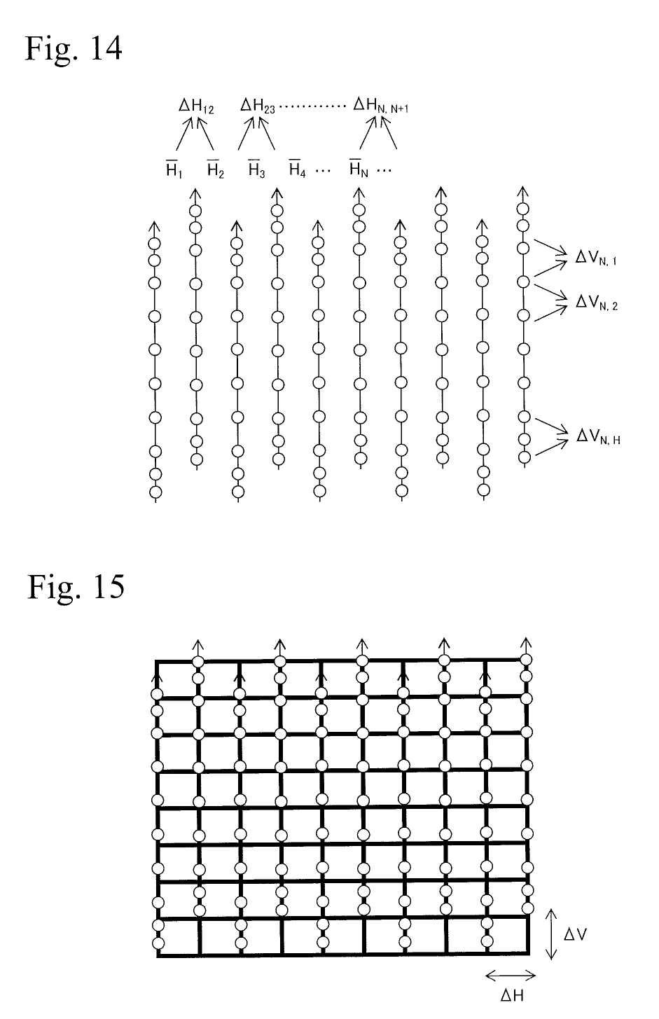

A processing of forming the grid will be described hereinafter. FIG. 14 shows point cloud data in which distances between the points are not constant, and FIG. 15 shows a formed grid. As shown in FIG. 14, an average horizontal distance H_{1-N} of each line is obtained, and a difference ΔH_{i,j} of the average horizontal distance between the lines is calculated. Then, the difference ΔH_{i,j} is averaged and obtained as a horizontal distance ΔH of the grid (Second Formula). In regard to distances in the vertical direction, a distance ΔV_{N,H} between adjacent points in each line in the vertical direction is calculated. Then, an average of ΔV_{N,H} in the entire image of an image size W, H is obtained as a vertical distance ΔV (Third Formula). As shown in FIG. 15, a grid with the calculated horizontal distance ΔH and the calculated vertical distance ΔV is formed.

(ΣΔH_{i,j})/(N−1)=ΔH Second Formula

(ΣΔV_{N,H})/(W×H)=ΔV Third Formula

Next, the nearest points are registered on the intersection points of the formed grid. In this case, predetermined threshold values are set for distances from each point to the intersection points so as to limit the register of the points. For example, the threshold values may be set to be half of the horizontal distance ΔH and be half of the vertical distance ΔV. As in the case of the linear interpolation method and the bicubic method, all points may be corrected by adding weight according to the distances to the intersection points therefrom. In this case, if interpolation is performed, the points are essentially not measured points.

The point cloud data that are thus obtained are output to the point cloud data processing unit 100′. The point cloud data processing unit 100′ performs the processing that is described in the First Embodiment. As a result, an obtained image is displayed on the display 7 of the liquid crystal display. This structure is the same as in the case that is described in the First Embodiment.

The point cloud data processing unit 100′ has the same structure as the point cloud data processing device 100 in FIG. 1 except that the image display device 109 and the instruction input device 110 are not included. In this case, the point cloud data processing unit 100′ is a piece of hardware formed of a dedicated integrated circuit using a FPGA. The point cloud data processing unit 100′ processes point cloud data in the same manner as in the point cloud data processing device 100.

### Modification

In the structure of the controlling unit 26, the grid forming unit 9 may be made so as to output the point cloud data. In this case, the point cloud data processing device 1 functions as a three-dimensional laser scanner, which can be used in combination with the point cloud data processing device 100 in the First Embodiment. On the other hand, by combining the three-dimensional laser scanner, in which the grid forming unit 9 outputs the point cloud data, and the point cloud data processing device 100 in FIG. 1, a point cloud data processing system using the present invention is obtained. In this case, the point cloud data processing device 100 is made so as to receive the output of the three-dimensional laser scanner and performs the processing described in the First Embodiment.

### 3. Third Embodiment

A point cloud data processing device equipped with an image measuring unit that has stereo cameras will be described hereinafter. The same components as in the First and the Second Embodiments are indicated by the same reference numerals as in the case of the First and the Second Embodiments, and descriptions thereof are omitted.

### Structure of Point Cloud Data Processing Device

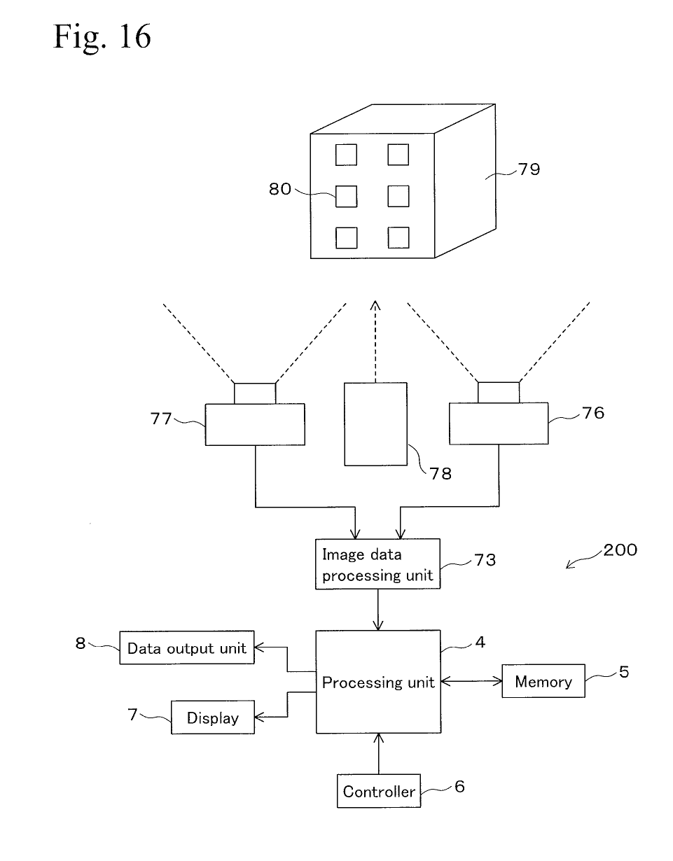

FIG. 16 shows a point cloud data processing device 200. The point cloud data processing device 200 has a combined structure of a point cloud data processing function using the present invention and an image measuring function that is provided with stereo cameras. The point cloud data processing device 200 photographs an object from different directions in overlapped photographing areas and obtains overlapping images, and it matches feature points in the overlapping images. Then, the point cloud data processing device 200 calculates three-dimensional coordinates of the feature points based on positions and directions of photographing units and positions of the feature points in the overlapping images. The positions and the directions of the photographing units are preliminary calculated. Next, the point cloud data processing device 200 forms point cloud data by linking the two-dimensional images and the three-dimensional coordinates based on disparity of the feature points in the overlapping images, the measurement space, and a reference shape. Moreover, the point cloud data processing device 200 performs the plane labeling and calculates data of contours, based on the point cloud data. Furthermore, the point cloud data processing device 200 performs remeasurement of the point cloud data and recalculation based on the remeasured point cloud data, which are described in the First Embodiment.

FIG. 16 is a block diagram showing a structure of the point cloud data processing device 200. The point cloud data processing device 200 is equipped with photographing units 76 and 77, a feature projector 78, an image data processing unit 73, a processing unit 4, a memory 5, a controller 6, a display 7, and a data output unit 8. The photographing units 76 and 77 are used for obtaining stereo images and may be digital cameras, video cameras, CCD cameras (Charge Coupled Device Cameras) for industrial measurement, CMOS cameras (Complementary Metal Oxide Semiconductor Cameras), or the like. The photographing units 76 and 77 function as stereo cameras that photograph an object from different positions in overlapped photographing areas. The number of the photographing units is not limited to two and may be three or more.

The feature projector 78 may be a projector, a laser unit, or the like. The feature projector 78 projects random dot patterns, patterns of a point-like spotlight or a linear slit light, or the like, to the object. As a result, portions having few features of the object are characterized, whereby image processing is easily performed. The feature projector 78 is used primarily in cases of precise measurement of artificial objects of middle to small size with few patterns. In measurements of relatively large objects normally outdoors, and in cases in which precise measurement is not necessary, or in cases in which the object has features or patterns that can be applied to the object, the feature projector 78 may not be used.

The image data processing unit 73 transforms the overlapping images that are photographed by the photographing units 76 and 77 into image data that are processable by the processing unit 4. The memory 5 stores various programs, an integrating and controlling program for these programs, and various data such as point cloud data and image data. The programs include programs for measuring photographing position and direction and programs for extracting feature points from the overlapping images and matching them. The programs also include programs for calculating three-dimensional coordinates based on the photographing position and direction and positions of the feature points in the overlapping images. Moreover, the programs include programs for identifying mismatched points and forming point cloud data and programs for extracting planes from the point cloud data and calculating contours. Furthermore, the programs include programs for displaying images of the calculated contours on the display 7 and programs for controlling processing relating to remeasurement of the point cloud data.

The controller 6 is controlled by a user and outputs instruction signals to the processing unit 4. The display 7 displays processed data that are processed by the processing unit 4, and the data output unit 8 outputs the processed data to the outside. The processing unit 4 receives the image data from the image data processing unit 73. The processing unit 4 measures the positions and the directions of the photographing units 76 and 77 based on photographed images of a calibration object 79 when two or more fixed cameras are used. In addition, the processing unit 4 extracts feature points from within the overlapping images of the object and matches them. Then, the processing unit 4 calculates three-dimensional coordinates of the object based on the positions of the feature points in the overlapping images, thereby forming point cloud data 2. Moreover, the processing unit 4 extracts planes from the point cloud data 2 and calculates contours of the object.

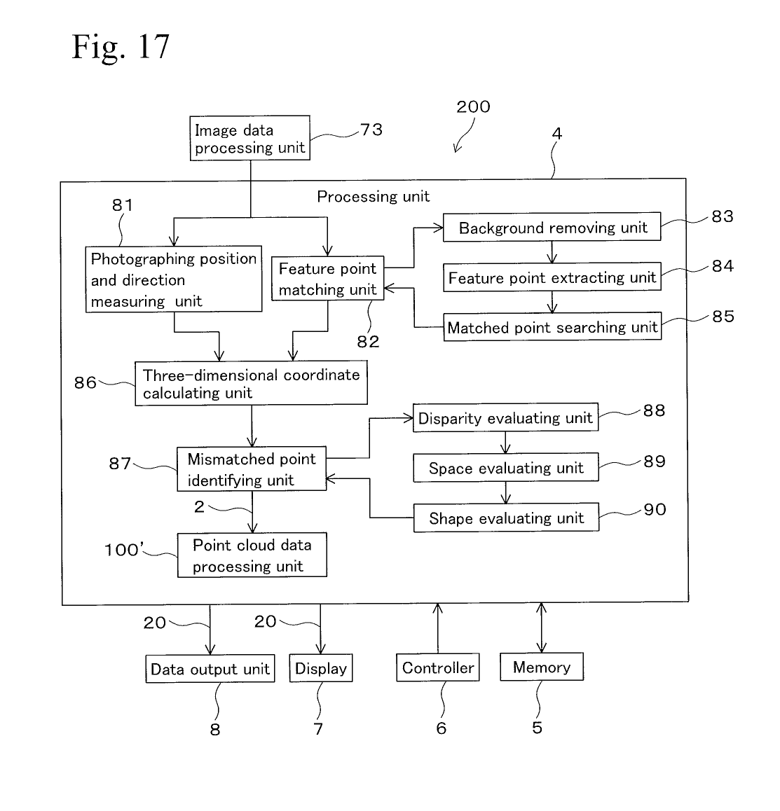

FIG. 17 is a block diagram of the processing unit 4. The processing unit 4 has a point cloud data processing unit 100′, a photographing position and direction measuring unit 81, a feature point matching unit 82, a background removing unit 83, a feature point extracting unit 84, and a matched point searching unit 85. The processing unit 4 also has a three-dimensional coordinate calculating unit 86, a mismatched point identifying unit 87, a disparity evaluating unit 88, a space evaluating unit 89, and a shape evaluating unit 90.

The point cloud data processing unit 100′ has the same structure as the point cloud data processing device 100 in FIG. 1 except that the image display device 109 and the instruction input device 110 are not included. In this case, the point cloud data processing unit 100′ is a piece of hardware formed of a dedicated integrated circuit using a FPGA. The point cloud data processing unit 100′ processes point cloud data in the same manner as in the point cloud data processing device 100.

The photographing position and direction measuring unit 81 receives image data of the overlapping images, which are photographed by the photographing units 76 and 77, from the image data processing unit 73. As shown in FIG. 16, the calibration object 79 is affixed with targets 80 (retro target, code target, or color code target) at predetermined distances. The photographing position and direction measuring unit 81 detects image coordinates of the targets 80 from the photographed images of the calibration object 79 and measures positions and directions of the photographing units 76 and 77 by publicly known methods. The method may be a relative orientation method, a single photo orientation or a DLT (Direct Linear Transformation) method, or a bundle adjusting method. The relative orientation method, the single photo orientation or the DLT method, and the bundle adjusting method, may be used separately or in combination.

The feature point matching unit 82 receives the overlapping images of the object from the image data processing unit 73, and it extracts feature points of the object from the overlapping images and matches them. The feature point matching unit 82 is formed of the background removing unit 83, the feature point extracting unit 84, and the matched point searching unit 85. The background removing unit 83 generates an image with no background, in which only the object is contained. In this case, a background image, in which the object is not contained, is subtracted from the photographed image of the object. Alternatively, target portions are selected by a user with the controller 6, or target portions are automatically extracted by using models that are preliminary registered or by automatically detecting portions with abundant features. If it is not necessary to remove the background, the processing of the background removing unit 83 may be skipped.

The feature point extracting unit 84 extracts feature points from the image with no background. In order to extract the feature points, a differentiation filter such as a Sobel, Laplacian, Prewitt, and Roberts, is used. The matched point searching unit 85 searches matched points, which correspond to the feature points extracted from one image, in the other image. In order to search the matched points, a template matching method such as a sequential similarity detection algorithm method (SSDA), a normalized correlation method, and an orientation code matching (OCM), is used.

The three-dimensional coordinate calculating unit 86 calculates three-dimensional coordinates of each of the feature points based on the positions and the directions of the photographing units 76 and 77 that are measured by the photographing position and direction measuring unit 81. This calculation is performed also based on image coordinates of the feature points that are matched by the feature point matching unit 82. The mismatched point identifying unit 87 identifies mismatched points based on at least one of disparity, the measurement space, and a reference shape. The mismatched point identifying unit 87 is formed of the disparity evaluating unit 88, the space evaluating unit 89, and the shape evaluating unit 90.

The disparity evaluating unit 88 forms a histogram of disparity of the feature points matched in the overlapping images. Then, the disparity evaluating unit 88 identifies feature points, of which the disparity is outside a predetermined range from an average value of the disparity, as mismatched points. For example, an average value±1.5σ (standard deviation) may be set as a threshold value. The space evaluating unit 89 defines a space within a predetermined distance from the center of gravity of the calibration object 70, as a measurement space. In addition, the space evaluating unit 89 identifies feature points as mismatched points when three-dimensional coordinates of the feature points, which are calculated by the three-dimensional coordinate calculating unit 86, are outside the measurement space. The shape evaluating unit 90 forms or retrieves a reference shape (rough planes) of the object from the three-dimensional coordinates of the feature points, which are calculated by the three-dimensional coordinate calculating unit 86. In addition, the shape evaluating unit 90 identifies mismatched points based on distances between the reference shape and the three-dimensional coordinates of the feature points. For example, TINs (Triangulated Irregular Networks) with a side of not less than a predetermined length are formed based on the feature points. Then, TINs with a long side are removed, whereby rough planes are formed. Next, mismatched points are identified based on distances between the rough planes and the feature points.

The mismatched point identifying unit 87 forms point cloud data 2 by removing the mismatched points that are identified. The point cloud data 2 has a directly linked structure in which the two-dimensional images are linked with the three-dimensional coordinates. When distances between adjacent points of the point cloud data 2 are not constant, as described in the Second Embodiment, the processing unit 4 must have the grid forming unit 9 between the mismatched point identifying unit 87 and the point cloud data processing unit 100′. In this case, the grid forming unit 9 forms a grid (meshes) with equal distances and registers the nearest points on the intersection points of the grid. Then, as described in the First Embodiment, planes are extracted from the point cloud data 2, and contours of the object are calculated. Moreover, the point cloud data is obtained again in an area of which point cloud data need to be remeasured.

There are two methods for the remeasurement of the point cloud data in this embodiment. In one of the methods, images are photographed again by the photographing units 76 and 77, and the point cloud data of a selected area is remeasured. This method is used when the point cloud data included noises because a passing vehicle was photographed in the image and when the point cloud data were not correctly obtained due to weather. In the other method, the previously obtained data of the photographed images is also used, and calculation is performed by setting density of the feature points higher, whereby the point cloud data is remeasured. Unlike the case of the three-dimensional laser scanner in the Second Embodiment, the density (resolution) of the images that are photographed by the photographing units 76 and 77 depends on the performances of the cameras. In this regard, even if the object is photographed again, there may be cases in which images with higher density are not obtained, as long as the photographing conditions are the same as before. In such case, the method of obtaining point cloud data with higher density by setting the density of the feature points in a selected area higher and performing recalculation is effective.

According to the Third Embodiment, point cloud data consisting of two-dimensional images and three-dimensional coordinates are obtained by the image measuring unit. The image measuring unit may be made so as to output the point cloud data from the mismatched point identifying unit 87. In addition, the point cloud data processing device 100 in FIG. 1 may be made so as to receive the output of this image measuring unit and perform the processing described in the First Embodiment. In this case, by combining the image measuring unit and the point cloud data processing device 100, a point cloud data processing system using the present invention is obtained.

### INDUSTRIAL APPLICABILITY

The present invention can be used in techniques of measuring three-dimensional information.

What is claimed is:

1. A point cloud data processing device for processing point cloud data including points of non-plane areas and plane areas of an object, the device comprising:
a non-plane area removing unit for removing the points of the non-plane areas based on the point cloud data of the object;
a plane labeling unit for adding identical labels to points in the same planes other than the points removed by the non-plane area removing unit so as to label planes;
a contour calculating unit for calculating a contour at a portion between a first plane and a second plane, which have the non-plane area therebetween and which have a different label, the contour differentiating the first plane and the second plane; and
a point cloud data remeasurement request processing unit for requesting remeasurement of the point cloud data based on at least one of results of the processing performed by the non-plane area removing unit, the plane labeling unit, and the contour calculating unit,
wherein the contour calculating unit includes a local area obtaining unit for obtaining a local area between the first plane and the second plane and includes a local space obtaining unit for obtaining a local plane or a local line, the local area connects with the first plane and is based on the point cloud data of the non-plane area, the local plane fits to the local area and differs from the first plane and the second plane in direction, the local line fits to the local area and is not parallel to the first plane and the second plane, and the contour calculating unit calculates the contour based on the local plane or the local line.

2. The point cloud data processing device according to claim 1, wherein the point cloud data remeasurement request processing unit requests remeasurement of the point cloud data of the non-plane area.

3. The point cloud data processing device according to claim 1, further comprising an accuracy evaluating unit for evaluating accuracy of the addition of the identical labels and the accuracy of the calculation of the contour, wherein the point cloud data remeasurement request processing unit requests remeasurement of the point cloud data based on the evaluation performed by the accuracy evaluating unit.

4. The point cloud data processing device according to claim 1, further comprising a receiving unit for receiving instruction for requesting remeasurement of the point cloud data of a selected area.

5. The point cloud data processing device according to claim 1, wherein the remeasurement of the point cloud data is requested so as to obtain point cloud data at higher density than the point cloud data that are previously obtained.

6. The point cloud data processing device according to claim 1, wherein the point cloud data contain information relating to intensity of light that is reflected at the object, the point cloud data processing device further comprises a two-dimensional edge calculating unit for calculating a two-dimensional edge based on the information relating to the intensity of the light, the two-dimensional edge forms a figure within the labeled plane, and the point cloud data remeasurement request processing unit requests remeasurement of the point cloud data based on result of the calculation performed by the two-dimensional edge calculating unit.

7. The point cloud data processing device according to claim 1, further comprising:
a rotationally emitting unit for rotationally emitting distance measuring light on an object;
a distance measuring unit for measuring a distance from the point cloud data processing device to a measured point on the object based on flight time of the distance measuring light;
an emitting direction measuring unit for measuring emitting direction of the distance measuring light;
a three-dimensional coordinate calculating unit for calculating three-dimensional coordinates of the measured point based on the distance and the emitting direction; and
a point cloud data obtaining unit for obtaining point cloud data of the object based on result of the calculation performed by the three-dimensional coordinate calculating unit, the point cloud data including points of non-plane areas and plane areas of the object,
wherein the non-plane area removing unit removes the points of the non-plane areas based on the point cloud data of the object.

8. The point cloud data processing device according to claim 1, further comprising:
a photographing unit for taking images of an object in overlapped photographing areas from different directions;
a feature point matching unit for matching feature points in overlapping images obtained by the photographing unit;
a photographing position and direction measuring unit for measuring the position and the direction of the photographing unit;
a three-dimensional coordinate calculating unit for calculating three-dimensional coordinates of the feature points based on the position and the direction of the photographing unit and positions of the feature points in the overlapping images; and
a point cloud data obtaining unit for obtaining point cloud data of the object based on result of the calculation performed by the three-dimensional coordinate calculating unit, the point cloud data including points of non-plane areas and plane areas of the object,
wherein the non-plane area removing unit removes the points of the non-plane areas based on the point cloud data of the object.

9. A point cloud data processing method for processing point cloud data including points of non-plane areas and plane areas of an object, the method comprising:
a non-plane area removing step for removing the points of the non-plane areas based on the point cloud data of the object;
a plane labeling step for adding identical labels to points in the same planes other than the points removed in the non-plane area removing step so as to label planes;
a contour calculating step for calculating a contour at a portion between a first plane and a second plane, which have the non-plane area therebetween and which have a different label, the contour differentiating the first plane and the second plane; and
a point cloud data remeasurement request processing step for requesting remeasurement of the point cloud data based on at least one of results of the processing performed by the non-plane area removing step, the plane labeling step, and the contour calculating step,
wherein the contour calculating step includes a local area obtaining step for obtaining a local area between the first plane and the second plane and includes a local space obtaining step for obtaining a local plane or a local line, the local area connects with the first plane and is based on the point cloud data of the non-plane area, the local plane fits to the local area and differs from the first plane and the second plane in direction, the local line fits to the local area and is not parallel to the first plane and the second plane, and the contour is calculated based on the local plane or the local line.

10. A point cloud data processing program for processing point cloud data including points of non-plane areas and plane areas of an object, which is read and is executed by a computer so that the computer has the following functions comprising:
a non-plane area removing function for removing the points of the non-plane areas based on the point cloud data of the object;
a plane labeling function for adding identical labels to points in the same planes other than the points removed by the non-plane area removing function so as to label planes;
a contour calculating function for calculating a contour at a portion between a first plane and a second plane, which have the non-plane area therebetween and which have a different label, the contour differentiating the first plane and the second plane; and
a point cloud data remeasurement request processing function for requesting remeasurement of the point cloud data based on at least one of results of the processing performed by the non-plane area removing function, the plane labeling function, and the contour calculating function,
wherein the contour calculating function includes a local area obtaining function for obtaining a local area between the first plane and the second plane and includes a local space obtaining function for obtaining a local plane or a local line, the local area connects with the first plane and is based on the point cloud data of the non-plane area, the local plane fits to the local area and differs from the first plane and the second plane in direction, the local line fits to the local area and is not parallel to the first plane and the second plane, and the contour is calculated based on the local plane or the local line.
